(19) United States
(12) Patent Application Publication
(10) Pub. No.: US 2021/0140175 A1
(43) Pub. Date: May 13, 2021

(54) RAPIDLY DEPLOYABLE MODULAR BUILDING SYSTEM

(71) Applicant: HER MAJESTY THE QUEEN IN RIGHT OF CANADA AS REPRESENTED BY THE MINISTER OF NATURAL RESOURCES, Ottawa (CA)

(72) Inventor: Mark Austin DOUGLAS, Orleans (CA)

(73) Assignee: Her Majesty the Qeen in right of Canada as represented by the ministry of natural resources, Ottawa, ON (CA)

(21) Appl. No.: 16/644,809

(22) PCT Filed: Sep. 21, 2018
(86) PCT No.: PCT/CA2018/051188

§ 371 Date: Mar. 5, 2020

Related U.S. Application Data
(60) Provisional application No. 62/561,300, filed on Sep. 21, 2017.

(51) Int. Cl. E04C 2/296; E04C 2/292

(52) U.S. Cl. CPC E04C 2/296; B32B 5/18; E04C 2/292

(57) ABSTRACT

The invention involves using composite panels to a framework to create a standard reusable rapidly deployable building structure, even in remote areas under favourable weather conditions. The invention discloses a minimal set of components, assemblies and methods where logistics are simplified through the use of flat-pack shipping and minimal use of field fasteners/tools. No crane or specialized trades are required to construct the building on site Standardization allows for interchangeability of components for repair or changing of building dimensions either during the initial construction or later. Most components are commercially available materials joined into assemblies using simplified manufacturing operations to reduce costs. Most assemblies, including flanges and cleats connecting adjacent composite panels, rectangular and/or triangular lattice (truss), transom, pier, columns, shear pins with retention means, are re-usable should the building require repairs, re-purposing or relocation. A free-span interior is described maximizing flexibility for arrangement of interior rooms and furnishings.

### BACKGROUND OF THE INVENTION

Rapid construction of affordable housing, whether in crowded urban areas, developing countries, in remote or disaster relief areas poses, special challenges, for example, costs relating to transportation of materials, use of tools and lifting equipment and the need for specialized construction skills that are not always available on-site. Additionally, the energy efficiency of such structures may be compromised in the interest of rapid deployment for immediate use.

On-site erection of flexible wall shelters and various tent like structures has been used—particularly during emergencies or in remote areas. However, it is often difficult to provide adequate insulation in such structures in order to obtain good thermal performance. Additionally, the durability of such shelters is often less than desired under the circumstances.

Others have applied prefabricated modules for more permanent structures. However, such structures often occupy considerable space during transport which limits their applicability and/or they may require lifting means not present on site. Shelters designed to transport in collapsed form or those that can be made from parts and panel shapes that can be shipped flat-packed certainly show the most promise. Though such designs are available in the marketplace, they do not provide the degree of durability, weather resistance, thermal and fire performance required and they often call for fasteners, tools, and specialized trades skills not available on-site.

Traditional I lousing Structure

Wall/Floor/Roof Panels

Existing traditional wall panel assemblies typically comprise of, in the order from the exterior of a house or shelter to the interior: exterior wall cladding, gap creating furring strips, a weather-resistant but breathable layer, a wood products panel, wood or metal structural elements, insulation, a vapour barrier layer, and an inner lining made of gypsum board whose joints are taped and finished in the field in order to minimize fire penetration to the interior of the wall assembly.

The walls generally bear upon a foundation, which is set below the permafrost line in the ground, in order to ensure the building is stable and stationary throughout its life.

A traditional roof panel assembly is constructed similar to the wall description above, except the cladding, furring and weather-resistant layer are replaced with roof shingles applied to the exterior wood products panel, which is arranged at a suitable slope to shed rain, where the roof finish is supported by wood trusses that bear on the walls of the structure. Most notably, the space within the roof trusses is most often outside the building envelope and ventilated to the exterior by suitable means.

A traditional floor panel assembly is constructed by affixing a wood products panel to wood trusses or joists that bear on the foundation either directly or through the walls of the structure.

Most notably, the shortcoming of traditional wood frame construction lies in that it represents an assembly of materials and components performed in the field, which requires skilled trades persons, favourable weather conditions and the closing-off and heating of the building space during specific operations such as finishing of the interior drywall joints which is required for to establish the integrity of the building envelope—in particular the resistance of the structure to fire from within.

Traditional Truss/Support Structure

There are certain circumstances, for example, in areas with extreme climate or disaster stricken, or in areas where the ground bearing capacity is variable or limited, where a house or building structure would be preferably positioned above the ground and on a support structural system (for example, a foundation).

Generally speaking, there are three traditional approaches to assemble the support structural system.
(1) Traditional Post and Beam System: This system is consisted of wooden structural beams.
Among the disadvantages of this type of systems, the long and heavy wooden structural beams are difficult to ship to remote areas, for example, within 20 feet sea containers. Secondly, due to their weight, these structural beams are difficult to place by hand and as such, their assembly requires mechanical lifting means. Thirdly, these long wooden beams must be secured and generally they do not form part of a system when used as foundation beneath a house which results in the house settling differentially, thereby straining wall, floor and ceiling connections, leading to failure of the building envelope.
(2) Triangulated Space Frame System (or “multi-point foundation” or “Triodetic foundation”):
These are metal frameworks consisting of a set of hollow tubular steel or aluminum struts with serrated features at each end of each strut, where said serrations fit snugly into hubs formed with matching serrated features, which are then secured with a single threaded bolt traversing the joint body.
Among the disadvantages of the triangulated space frame system, multiplicity of struts and field fasteners are required, which increases field labor. More importantly, when the triangulated space frame is used as a roof truss system, it requires the assembly of a multiplicity of struts overhead, and as a result the use of temporary bracing or a crane to elevate assemblies built up at ground level.
(3) Scaffolding System with Screw Jack Posts: This type of system is a metal framework consisting of piers and 2-d trusses and struts and joined in the field by scaffolding type connectors such that all components can be placed by hand and attached without the use of threaded field fasteners or tools other than a hammer.
Despite the beneficial feature of scaffold connector which permit tightening of joints during installation there remains a long-term concern over the use of demountable and re-usable scaffolding connectors for such buildings as they involve a degree of field supervision, inspection and maintenance in order to ensure building structural integrity as the connectors may become loose over time.

Therefore, there exists a constant need to:
Promote the use of durable lightweight materials such as aluminum or aluminum alloys wherever possible in building structural systems to reduce weight for easier shipping and handling.
Develop building structural systems that favour the minimization of part count by exploitation of factory made 2-D or “planar” assemblies that pack well for transport.
Develop 2-D assemblies that maximize the use of linear welds wherever possible in order to economize factory operations and reduce manufacturing costs.
Develop building structural systems that use standard, interoperable components, for example components that can be used in the foundation beneath the house as well as overhead in the superstructure, such that the number of parts required is minimized, improving manufacturing economics and inventory management.
Replace scaffold connectors with shear pins in order to improve the long-term security of the building structural system under a wide range of dynamic loading conditions.
Provide diagonals and bracing elements where required in the foundation or superstructure to impart torsional stability within the building structural system in order to accommodate differential ground settlements.

It is well established that houses built in permafrost regions face the significant challenge of preventing heat losses from the building envelope from contributing to thawing of the frozen ground around and beneath the home especially. Such thawing would lead to heaving of the ground, often in unpredictable and discontinuous ways, leading to improper support of the building envelope. Locations where the ground is frozen deeper than a foundation can be built economically face the additional challenge of finding a way to support the building envelope properly through the life of the building.

Most commonly this problem is solved by raising the building above the ground by use of a structure made on site using wood or metal. While several approaches are available, depending on the situation at site, the materials that are available and the local skill set, one preferred solution is the use of a metal space frame utilizing Triodetic^{TM} technology. The Triodetic technology uses hollow galvanized steel or aluminum tubes with swaged ends upon which are impressed serrations that slide into proprietary hub connectors. A great many arrangements of such tubes is possible, leading to efficient use of material and the spreading of loads to multiple foot pieces as is appropriate for fragile permafrost regions.

The Triodetic technology, however, is characterized by the need to assemble tubing to connectors at site in exchange for compact shipping dimensions because the space frame can be broken down into individual linear elements (tubes) and repeating connectors. The part count is generally high due to the multiplicity of tubes and connectors used however the economics are generally satisfactory because of the economy of the impression of serrations onto the tube ends, which is performed in a large capacity press using a technique called “coining”.

Triodetic connectors are close fitting to the serrated tube ends and it is known that though they are initially easy to install they can become more difficult to separate due to the accumulation of corrosion products between the joined elements. This is generally a small price to pay for the strength developed the joints which can carry significant moments while distributing stresses throughout the tube envelope at the connection, thus economizing on the overall use of material for the structure.

A Triodetic foundation system would generally be classified as a raised raft foundation made using three dimensional space frame principles with a significant amount of torsional stiffness overall. This approach allows various modes of operation including somewhere not all feet must be in contact with the soil beneath the house. Such modes are of benefit should the ground move and become discontinuous with the foundation system. Should this happen, the Triodetic foundation can be re-leveled by any means, but most commonly by manipulation of the height of the adjustable legs that are provided above the feet of the foundation and in contact with the ground.

Notwithstanding the above, the Triodetic foundation system incurs a penalty when time is limited on site, as it would be the case in most remote and northern areas, because of the relatively short construction season, which in some cases may only last a few weeks. While this may not be a problem for the construction of one or several houses, it becomes a major issue when many homes must be built in a few weeks. Furthermore, because it is well known that tens of thousands of new homes are required immediately across Canada's far north, there remains a pressing need to find ways to speed the assembly of the foundation system, as well as the building envelope.

There also remains a constant need for rapidly-deployable, cost-effective housing, in crowded urban areas, developing countries, and particularly in remote or disaster-stricken areas, where there is a shortage of supply of suitable accommodations for residents of the area due to circumstances caused by nature, distance to site, or lack of suitable technology.

The solution will need to involve aspects of design, supply chains for materials and the timely provision of specialized trades within the community. Increasingly, there is also the pressure of the high cost providing utilities such as electricity, heating fuel, potable water and waste removal.

Homes could be built using standard wood frame construction methods, for example, as detailed in Canada's Housing Construction System (CMHC publication 62966, revised 2011) and “The Canadian Wood Frame House Construction Guide” (CMHC publication 61199, revised 2014). These methods have evolved over years to enable the cost-effective use of wood and various other materials that can be shipped individually and supplied to experienced trades persons in the field.

The problem with traditional wood frame construction methods is the distance materials must be transported and the degree of protection required during transport and while on site waiting use, the lack of experienced trades persons in remote areas, the short building season and the onerous logistics of ensuring all required materials, fasteners, tools and equipment necessary are available at site when needed.

Therefore, there remains a need for rapidly-deployable, cost-effective housing solutions for application in remote or disaster-stricken areas, which does not preclude other applications that would benefit from such solutions, especially low cost housing for any social or institutional purpose.

The solution will preferably use modular and/or pre-made parts and a set of integrated methods in order to be able to rapidly deploy energy efficient housing in a wide range of applications.

The solution will preferably deliver improved thermal performance and durability at a reasonable cost, for example, it will be preferable to assemble the housing in a few days using only a few personnel, without specialized training or tools required. It would be further preferable if the housing can be assembled by the few personnel lifting all the parts into place by hand without the use of lifting devices, even under windy conditions.

The solution will preferably use interchangeable components, including removal and replacement of any component in-kind in order to repair the habitat should it become damaged.

To be able to respond to the unique challenges of housing in remote areas, it should also be possible to take apart, modify and relocate the housing should end user needs change.

The solution favours the local or regional stocking of fully interchangeable parts that can be arranged in standardized ways so that housing can be delivered, assembled and occupied sufficiently quickly to respond to immediate housing needs under a wide range of circumstances.

### SUMMARY OF THE INVENTION

According to the present invention, an energy efficient and cost effective house can be built by hand using a modular design which eliminates the use of fasteners wherever possible in order to facilitate assembly and reduce part count and therefore cost.

According to the present invention, such rapidly deployable building structure may be built in a few days without special tools, nor the use of lifting equipment, nor the use of skilled trades by a method that is described using easy to manufacture, well-insulated factory-finished components that are easy to transport to site and easy to assemble with a minimum of on-site labor.

The present invention also makes it possible for easy scaling, modification or repair by replacement of components or even the relocation and reuse of the entire house as a system, features which are not possible with traditional wood frame construction methods or other known pre-fabricated means of building construction.

A further benefit of such an approach is it enables one to accurately forecast the cost of the house by minimization of high risk items such as transport, delivery and field labour.

Yet a further benefit of such an approach is the cost reduction potential by virtue of standardization and mass production of a minimal set of parts used for building construction.

According to the present invention, there is provided a composite panel comprised of: (a) an outer layer (a); a core (b) layer (b); and (c) an inner sheet layer (c); wherein layer (a), layer (c), or both, comprise one or more layers of materials selected from the group consisting of plywood, oriented strand-board (OSB), plastic material, metal, and one or more boards made with cementitious or mineral materials in their oxidized form.

Preferably, layer (a), layer (c), or both, comprise plastic material, wherein said plastic material is with fiber reinforcement, preferably fiberglass woven in one or more directions, in one or more layers, or both.

Preferably, layer (a), layer (c), or both, comprises plastic material, wherein said plastic material is made of resin impervious to moisture and degradation, preferably said resin comprises phenolic compounds with heat and/or fire resistant properties.

Preferably, layer (b) comprises one or more layers of expanded or foamed materials selected from the group consisting of polystyrene (PS), polyurethane (PUR), polyisocyanurate (PIR), polyethylene terephthalate (PET), polyvinyl chloride (PVC), one or more layers of fibrous materials, and vacuum insulated panels, preferably said one or more layers of fibrous materials is selected from the group consisting of glass wool and mineral wool.

Preferably, layer (b) comprises a polystyrene (PS) layer sandwiched between two layers of polyisocyanurate (PIR), polyurethane (PUR), or combination of both.

Preferably, the composite panel further comprise a layer (d) located between layers (a) and (b), between layers (b) and (c), or between both layer (a) and (b) and layers (b) and (c), wherein layer (d) comprises an inorganic coated fibrous mat or slip sheet with fire resistant properties, preferably the slip sheet is made of inorganic material comprised of aluminum trihydrate.

Preferably, outer layer (a) of the composite panel is punctuated to allow moisture to diffuse outwards.

According to another aspect of the invention, there is provided a panel assembly comprising: two adjacent panels, two L-shaped flanges, each formed from a flat sheet bent along a bend line, each of said L-shaped flanges has a horizontal face and a vertical face, each of said panels is attached from the bottom to the horizontal face of each of the flanges in a direction away from the vertical face, the vertical face of each the flanges are placed parallel and abut with each other when the flanges are brought together, wherein each of the vertical face comprises apertures, protrusions, or both, wherein the apertures and/or protrusions located in the first vertical face are reciprocal with the protrusions and/or apertures located in the second vertical face as opposite pairs, wherein said apertures and/or protrusions located in the first vertical face mate with the protrusions and/or apertures located in the second vertical face when the first and second vertical faces are brought together across an abutting face that exists between the abutting flanges, and wherein said abutting face comprises flat area to provide a positive stop for the engagement of the protrusions and the apertures.

Preferably, the flat area further comprises an upper closure strip comprising a flat area on the vertical face above the apertures and/or protrusions; a lower closure strip comprising a flat area on the vertical face below the apertures and/or protrusions, or both.

Preferably, a sealant is added along the lower closure strip.

Preferably, the flanges are brought together by binding means. Preferably, the binding means is a removable cleat inserted top side longitudinally along the outer edges of vertical faces of the flanges.

According to one aspect of the invention, there is provided a panel assembly comprising: two adjacent panels, two L-shaped flanges, each formed from a flat sheet bent along a bend line, each of said L-shaped flanges has a horizontal face and a vertical face, each of said panels is attached from the bottom to the horizontal face of each of the flanges in a direction away from the vertical face, the vertical face of each of the flanges are placed parallel and abut with each other when the flanges are brought together by binding means, wherein the binding means is a removable cleat.

Preferably, the removable cleat is inserted top side longitudinally along the outer edges of vertical faces of the flanges.

Preferably, each of the vertical face comprises apertures, protrusions, or both, wherein the apertures and/or protrusions located in the first vertical face are reciprocal with the protrusions and/or apertures located in the second vertical face as opposite pairs, wherein said apertures and/or protrusions located in the first vertical face mate with the protrusions and/or apertures located in the second vertical face when the first and second vertical faces are brought together across an abutting face that exists between the abutting flanges, and wherein said abutting face comprises a flat area to provide a positive stop for the engagement of the protrusions and the apertures.

Preferably, each of the flanges bears an additional bend line, said bend line is substantially perpendicular to the abutting face to create a flat portion at the outer extremity of the flanges.

Preferably, the removable cleat is inserted top side longitudinally along the outer edges of vertical faces of the flanges and over the flat portion at the outer extremity of the flanges.

According to one aspect of the invention, there is provided a sealing assembly for providing a cover over an exterior material of a building structure, comprising: a double corded strap with two longitudinal edges, two Keder receiving channels each fastened to same side of the exterior material, wherein each longitudinal edge fits into each Keder receiving channel.

Preferably, the Keder receiving channels are corrosion resistant. Preferably, the exterior material is cladding. Preferably, the cladding is placed over abutting seam of two adjacent panels abutting with each other. Preferably, the double corded strap is placed over the apex of a building structure.

According to one aspect of the invention, there is provided a triangular structural support assembly, comprising: a triangular lattice within a building unit, said building unit is a cubic structure comprises four rectangular lattices connected to each other, said triangular lattice communicates with the lower opposed corners of the building unit each by a tubular connecting assembly.

According to one aspect of the invention, there is provided a triangular structural support assembly, comprising: a triangular lattices within a building unit, said building unit is a cubic structure comprises four rectangular lattices connected to each other, said triangular lattice communicates with the lower opposed corners of the building unit each by a tubular connecting assembly, wherein the apex of the triangular lattice to the lower opposed corners of the building unit are of equal distance, wherein the building unit supports a panel place there above, wherein the apex of the triangular lattice is coincident to the centroid of the lower surface of the panel located above the building unit, wherein the apex communicates with said centroid by fastening means.

According to one aspect of the invention, there is provided a tubular connecting assembly, comprising: a tubular element, said tubular element bears a pair of holes aligned in any orientation relative to the tubular element for receiving a removable pin, wherein the pin optionally further transects with an object placed inside the tubular element.

According to one aspect of the invention, there is provided a structural beam, comprising: two pieces of metal sheets, said metal sheets are joined vertically together with an object inserted therein between by connecting means, said connecting means transects the two metal sheets and the object, said metal sheets are joined in the shape of an I-beam, said object protrudes longitudinally outside the end of the I-beam, the top portion of each of the two sheets flares out forming a pocket for receiving a pair of vertical flanges inserted therein to restrain lateral movement of the flanges.

According to one aspect of the invention, there is provided a structural beam hub connector assembly, comprising: a fluted solid object, said fluted object comprises one or more vertical grooves along the vertical length and on the outer surface of the fluted object, wherein said vertical groove is to receive a vertical object to be inserted into the vertical groove, wherein said vertical object has an end in the shape of a flared-out tongue, wherein the distance between the upper and lower extremities of the flared-out tongue is equal or greater than the vertical length of the fluted object, wherein said fluted object is cupped by an upper washer at the top end of the fluted object, wherein said fluted solid object is cupped by a lower washer at the bottom end of the fluted object, wherein the fluted object is held by a rod by fastening means to the rest of the structural beam hub connector assembly, tightening means to tighten the upper cupper washer against the fluted solid object, wherein when the a vertical object inserted into the vertical groove, the upper and lower cupped washers are tightened towards each other by applying the tightening means to cause the upper and lower cupped washers to squeeze against the flared-out tongue rather than against the solid object, to securely connect the vertical object to the structural beam hub connector assembly.

According to one aspect of the invention, there is provided a movement restraining structure, comprising: a plate, said plate has an aperture wherein the plate can be inserted over the threaded end of a rod, said rod is connected to a structural element, a protrusion securely connected on top of said plate, wherein a tubular element is inserted above said protrusion and stopped on the plate with the plate supporting the tubular element, wherein the protrusion inserted in the tubular element restrains the lateral movement of said tubular element.

According to one aspect of the invention, there is provided a method for forming a roof support of a building structure, comprising the steps of: assembling horizontally a rigid frame assembly comprising two columns, piers and one or more rectangular lattices, tilting the rigid frame assembly upwards wherein the bottom of the columns are placed onto a movement restraining structure comprising protrusions on top of a plate wherein said movement restraining structure is located on a pier or a structural beam hub assembly, restraining movement of the rigid frame assembly by the close fit up of wall panels adjacent to the columns, wherein the wall panels are fastened around the columns by a cleat inserted top end longitudinally along the outer edges of vertical faces of flanges attached to the wall panels, adding sequential placement overhead of piers and rectangular lattice, repeating the above steps along the direction of the building length, forming the roof support of a building structure.

According to one aspect of the invention, there is provided a reusable pin with retention means for securing tubular structure element, said pin comprising: a linear element, a vertical element, and a circular element with a tail end wherein the tail end is the last point of contact between said pin and the outer surface of a tubular element, wherein the linear element is at 90 degree angle and in the same plane with the vertical element, wherein the length of linear element is less than the length of vertical element, wherein vertical element is at 90 degree to circular element, wherein circular element travels around the circumference of the tubular element, wherein said pin is positioned where its vertical element is parallel with the length of the tubular element when the linear element is inserted horizontally through holes located on the tubular element, followed by rotation of the circular element into a final position where the tail end is the last point of contact between said pin and the outer surface of the tubular element, wherein the rotation of circular element is a sprung action with a rotation angle, wherein the rotation angle is greater than 180 degrees.

According to one aspect of the invention, there is provided a method for building a rapidly deployable building structure, comprising the steps of:

(a) constructing a floor support unit by connecting four rectangular lattices to four piers by tubular connecting assemblies,

(b) optionally diagonalizing the floor support unit by constructing one or more triangular lattices within said unit,

(c) connecting four structural beams or transoms onto the floor support unit by using structural beam hub connecting assembly,

(d) repeating steps (a) to (c) until floor support is built,

(e) laying floor composite panels on squares of four structural beams or transoms connected on top of the floor support,

(f) adding corner wall composite panels,

(g) building one column next to in each of the corner wall composite panels wherein the column fits snuggly into a profile edge created in the corner wall composite panels,

(h) adding wall composite panel next to the columns,

(i) forming a roof support of a building structure, comprising the steps of:
1) assembling horizontally a rigid frame assembly comprising two columns, piers and one or more rectangular lattices,
2) tilting the rigid frame assembly upwards wherein the bottom of the columns are placed onto a movement restraining structure comprising a protrusion on top of a plate wherein said movement restraining structure is located on a pier or a structural beam hub connector assembly,
3) restraining movement of the rigid frame assembly by the close fit up of wall panels adjacent to the columns, wherein the wall panels are fastened around the columns by a cleat inserted top end longitudinally along the outer edges of vertical faces of flanges attached to the wall panels,
4) adding sequential placement overhead of piers and rectangular lattice to form a roof support unit,
5) diagonalizing the roof support unit by constructing one or more triangular lattices within said unit,
6) repeating steps 1) to 5) along the direction of the building length,
7) forming the roof support of a building structure,

(k) connecting four structural beams or transoms onto the roof support unit by using structural beam hub connecting assembly,

(l) laying roof composite panels on squares of four structural beams or transoms connected on top of the roof support,

(m) adding wall composite panels, columns and corner wall composite panels to finish the building structure,

(n) optionally strapping the building structure, and

(o) optionally adding a roof finish to the building structure.

According to the present invention, a roof fabric system is also disclosed. The roof fabric system is edge-retained using Keder cords and Keder type extrusions to join its upper surface, where said at least one set of Keder extrusions runs along the apex of the roof line. Additional Keder type extrusions may be located periodically along the building length such that they run from the apex down to the drip line, in order to break the roof fabric system into easy to handle pieces with the additional benefit of introducing edge restraints for smaller individual fabric pieces that is helpful to preventing fluttering of the roof fabric under wind, especially when the lower extremity of such additional Keder extrusions is affixed to the building wall near the drip line.

Preferably, the roof fabric is draped onto a compliant layer or layers of vapour permeable insulation which may be separated by heat reflecting layers.

Preferably, the roof fabric finish is lightly tensioned by drawing down on the roof fabric using horizontal stiffeners embedded in the fabric at the drip line, where the fabric is relieved periodically to expose the stiffener, where such exposure allows attachment by any means to a double cord

Keder strap, which then proceeds down to an attachment point on the saddles used to support the wall panels, where such saddles are pinned to the foundation.

Preferably, the double cord Keder strap secures the roof fabric system to the foundation while at the same time covering the seam between wall panels by virtue of the routing of the double cord Keder strap through Keder channels located on each side of the wall panel seams.

Preferably, the eave area beneath the roof fabric is exposed to facilitate ventilation of the insulation underneath the roof fabric, so that water vapour that may enter the region underneath the roof fabric from inside the building is expelled via the ventilation pathway through the Keder channel at the apex of the roof line under the influence of the vapour gradient that may exist between the interior of the building and the exterior, especially during winter conditions, or by being drawn into a thermally induced flow of air beneath the roof finish as would be understood by one skilled in the art.

Preferably, the compliance of the underlying insulation serves to protect the roof fabric finish when walked upon, and to provide an extra measure of safety for workers walking on the roof.

Preferably, additional plane of straps, one on each side of the wall seams, are located under the double cord Keder strap used to retain the roof finish, where said second plane of straps so located inboard can be used for the purpose of retaining the building to the foundation independently of the double cord Keder straps located outboard and used to retain the roof finish, allowing the roof finish to be repaired by replacement without disconnecting any of the straps used to retain the building to the foundation, while relieving the second plane of straps from any UV exposure and potential vandalism by their position and therefore concealment, thus allowing traditional fiber reinforced plastic straps to be used using traditional wire type buckles fitted using a traditional hand tool for tensioning of the building structural straps once in position, allowing the use of low cost strapping normally used for shipping purposes to be used for our purpose which is to retain the building to the foundation in a manner that does not constrain the replacement of the roof finish nor introduce damage caused by exposure to UV radiation or vandalism.

It will be readily apparent to a person skilled in the art that the location of the second plane of straps which are used for structural purposes, one either side of the wall panel seams, is preferred for securing the lower corners of the wall panels to the saddles which bear onto the foundation system. Such securing means limit the uplift potential for individual wall panels that may be induced by wind and or seismic loads leading to racking of independent wall panels, thereby completing an easy, safe, economical and therefore optimum means for securing the building to the foundation.

### BRIEF DESCRIPTION OF THE DRAWINGS

The above-mentioned and other features and objects of this invention, and the manner of attaining them, will be better understood by reference to the following description of embodiments of the invention taken in conjunction with the accompanying drawings, wherein:

FIG. 1a is a schematic illustration of an embodiment of a composite panel of the present invention;

FIG. 1b is a schematic illustration of an embodiment of an outer layer of a composite panel of the present invention;

FIG. 1c is a schematic illustration of an embodiment of an outer layer of a composite panel of the present invention;

FIG. 1d is a schematic illustration of an embodiment of a core layer of a composite panel of the present invention;

FIG. 1e is a schematic illustration of an embodiment of a composite panel of the present invention with apertures to allow diffusion of moisture;

FIG. 1f is a schematic illustration of an embodiment of a composite panel of the present invention with additional layer(s);

FIG. 1g is a schematic illustration of an embodiment of a composite panel of the present invention with core layer and additional layer(s);

FIG. 1h is a schematic illustration of an embodiment of a composite panel of the present invention with VIP or Vacuum Insulated product;

FIG. 1i is a schematic illustration of an embodiment of a composite panel of the present invention with further additional layer(s);

FIG. 1j is a schematic illustration of an embodiment of a composite panel of the present invention with cladding present towards the exterior of the composite panel;

FIG. 1k is a schematic illustration of an embodiment of a composite panel of the present invention with an edge profile;

FIG. 2a is a schematic illustration of an embodiment of flanges as flat sheets with bend line according to the present invention;

FIG. 2b is a side view of an embodiment of the flanges bent with vertical faces and interacting with the composite panels according to the present invention;

FIG. 2c is a schematic illustration of an embodiment of flanges as flat sheets with bend line and with apertures and protrusions according to the present invention;

FIG. 2d is a perspective view of an embodiment of a pair of flanges bent with vertical faces and with reciprocal apertures and protrusions interacting with each other according to the present invention;

FIG. 2e is a schematic illustration of an embodiment of flanges as flat sheets with bend line and with apertures and protrusions and closure strips according to the present invention;

FIG. 2f is a side view of an embodiment of the flanges bent with vertical faces and with apertures and protrusions and closure strips interacting with each other and the composite panels according to the present invention;

FIG. 2g is a side view of an embodiment of the flanges bent with vertical faces and with apertures and protrusions and closure strips interacting with each other and secured by the action of a removable cleat according to the present invention;

FIG. 2h is a side view of an embodiment of the flanges bent with vertical faces and with apertures and protrusions and closure strips interacting with each other and secured by the action of a removable cleat and with linings according to the present invention;

FIG. 2i is a side view of an embodiment of the flanges bent with vertical faces and with apertures and protrusions and closure strips interacting with each other and secured by the action of a removable cleat and with exterior material (claddings) according to the present invention;

FIG. 3a is a perspective view of an embodiment of floor support unit and the roof support unit each comprised of 2-D rectangular lattices and 1-D piers according to the present invention;

FIG. 3b is a side view of an embodiment of a 2-D rectangular lattice with tubular connecting assemblies according to the present invention;

FIG. 3c is a side view of an embodiment of the tubular connecting assembly according to the present invention;

FIG. 3d is a side view of an illustrative embodiment of a 2-D rectangular lattice with the tubular connecting assemblies according to the present invention;

FIG. 3e is a schematic illustration of an internal profile of the tubular connecting assembly according to the present invention;

FIG. 3f is a schematic illustration of an internal profile of the horizontal tubes in the 2-D rectangular lattices according to the present invention;

FIG. 3g is a side view of an illustrative embodiment of a 2-D rectangular lattice with the tubular connecting assemblies according to the present invention;

FIG. 3h is a side view another illustrative embodiment of a 2-D rectangular lattice with the tubular connecting assemblies according to the present invention;

FIG. 4a is a perspective view of a 2-D triangular lattice within a repeating building unit according to the present invention;

FIG. 4b is a side view of an illustrative embodiment of a 2-D triangular lattice with the tubular connecting assemblies according to the present invention;

FIG. 4c is a side view of an illustrative embodiment of a 2-D triangular lattice with the tubular connecting assemblies according to the present invention;

FIG. 4d is a side view of an illustrative embodiment of a 2-D triangular lattice with the tubular connecting assemblies according to the present invention;

FIG. 5a is a side view of a 1-D pier with protrusions and upper and lower assemblies as attachment means according to the present invention;

FIG. 5b is a top view of an illustrative and non-limiting example of a bolted protrusion on the 1-D pier according to the present invention;

FIG. 5c is a side view of an illustrative and non-limiting example of a bolted protrusion on the 1-D pier according to the present invention;

FIG. 5d is a top view of an illustrative and non-limiting example of a bolted protrusion on the 1-D pier according to the present invention;

FIG. 5e is a top view of an illustrative and non-limiting example of an eye bolt on the 1-D pier according to the present invention;

FIG. 5f is a top view of an illustrative and non-limiting example with casting/or forging (left) or welding (right) protrusions on the 1-D pier according to the present invention;

FIG. 5g is a side view of an illustrative and non-limiting example with casting/forging (left) or welding (right) or forging protrusions on the 1-D pier according to the present invention;

FIG. 6a is a perspective view of an embodiment of a 1-D transom interacting with a building unit and a composite panel according to the present invention;

FIG. 6b is an end view of an embodiment of a 1-D transom interacting with horizontal composite panels according to the present invention;

FIG. 6c is a side of an embodiment of a 1-D transom interacting with a transom hub connector according to the present invention;

FIG. 6d is a top end view of an embodiment of the fluted solid object within a transom hub connector according to the present invention;

FIG. 6e is a side view of an embodiment of a transom hub connector located in the interior of the building structure according to the present invention;

FIG. 6f is a side view of an embodiment of a transom hub connector located in the perimeter of the building structure according to the present invention;

FIG. 6g is a side view of an embodiment of a transom hub connector interacting with the receiving means on a 2-D rectangular lattice according to the present invention;

FIG. 6h is a perspective view of an embodiment of a transom hub connector interacting with the receiving means on a 2-D rectangular lattice according to the present invention;

FIG. 7a is a perspective view of an embodiment of 1-D columns emanating from a corner of the building structure according to the present invention;

FIG. 7b is a perspective view of an embodiment of a 1-D column interacting with wall composite panels according to the present invention;

FIG. 7c is a side view of an embodiment of a 2-D rigid frame assembly according to the present invention;

FIG. 8a is a perspective view of an embodiment of a 2-D triangular lattice interacting with the centroid of a horizontal composite panel according to the present invention;

FIG. 9a is a perspective view of an embodiment of a shear pin with retention means according to the present invention;

FIG. 9b is another perspective view of an embodiment of a shear pin with retention means according to the present invention;

FIG. 9c is a cross-section view of an embodiment of a shear pin with retention means according to the present invention;

FIG. 10a is a schematic illustration of an embodiment of the straps for the building structure according to the present invention;

FIG. 10b is a schematic illustration of an embodiment of straps and interaction between wall panel and floor/roof panel according to the present invention;

FIG. 10c is a schematic illustration of an embodiment of the straps interacting with the panel seams according to the present invention;

FIG. 11a is a schematic illustration of an embodiment of the roof finish and securing means according to the present invention;

FIG. 11b a schematic illustration of an embodiment of the securing means interacting with exterior material (claddings) according to the present invention;

FIG. 12a is a schematic illustration of an embodiment of the floor support unit according to the present invention;

FIG. 12b is a schematic illustration of an embodiment of the floor support unit with a 2-D triangular lattice according to the present invention;

FIG. 12c is a schematic illustration of an embodiment of the 1-D transoms on a diagonalized floor support unit according to the present invention;

FIG. 12d is a lower perspective view of an embodiment of the floor support unit built with 1-D transoms according to the present invention;

FIG. 12e is a schematic illustration of an embodiment of two floor support units according to the present invention;

FIG. 12f is a schematic illustration of an embodiment of multiple floor support units according to the present invention;

FIG. 12g is a schematic illustration of an embodiment of the floor support units with square floor composite panels according to the present invention;

FIG. 12h is a schematic illustration of an embodiment of the floor support units with square floor composite panels and triangular floor composite panels according to the present invention;

FIG. 12i is a schematic illustration of an embodiment of the floor support units with floor composite panels having notches according to the present invention;

FIG. 12j is a schematic illustration of an embodiment according to the present invention of the floor composite panel interacting with the 1-D column and the wall composite panel;

FIG. 13a is a schematic illustration of an embodiment of corner wall composite panels added to the floor support according to the present invention;

FIG. 13b is a schematic illustration of an embodiment of corner wall composite panels with 1-D column and wall composite panel added to the floor support according to the present invention;

FIG. 13c is a schematic illustration of an embodiment of a 2-D rigid frame assembly interacting with the building structure according to the present invention;

FIG. 13d is a schematic illustration of assembly of the building structure according to the present invention;

FIG. 13e is a schematic illustration of assembly of roof support with 2-D triangular lattices according to the present invention;

FIG. 13f is a schematic illustration of assembly of roof support with 1-D transoms according to the present invention;

FIG. 13g is a schematic illustration of an embodiment of the roof support units with square roof composite panels and triangular roof composite panels according to the present invention;

FIG. 14a is a schematic illustration of an embodiment of the building structure with suspender straps and belt straps according to the present invention; and

FIG. 14b is a schematic illustration of an embodiment of the building structure with roof finish and Keder securing means according to the present invention.

### DETAILED DESCRIPTION OF THE INVENTION

### Composite Panels

The present invention discloses, in general, an approach that uses a composite panel design which may be adapted by a person skilled the art to form walls, floor and roof panels for shelters of all kinds.

Most notably, the present invention discloses a method where the composite panels are shipped flat-packed, minimizing the volume and therefore cost of transport, arrive in the field fully finished and ready to be used for their final purpose, thus minimizing the amount and quality of site labor required.

Said composite panels can be unpacked and positioned in their destined place within the structure by hand, thus eliminating the need for mechanized lifting equipment on-site, and the use of traditional fasteners to complete the final structure, while facilitating the rapid assembly of the structure.

The present invention discloses a composite panel comprises:
an outer sheet—layer (a);
a core—layer (b); and
an inner sheet—layer (c).

Outer and inner are defined as relative to the exterior of the building structure with outer layer being the closest to the exterior and inner layer as being the furthest away from the exterior.

Referring to FIG. 1a, one embodiment of a composite panel 10 described herein comprises an outer layer sheet referred to as layer (a) 20, a core referred to as layer (b) 30, and an inner sheet referred to as layer (c) 40.

Layers (a) 20 and/or (c) 40 may be made of any suitable durable material adhered to layer (b) 30 by any means, where layer (b) may be made using any suitable expanded or foamed material with insulating and structural properties, where the strength of the so assembled composite panel is largely a function of the panel thickness once the various material properties have been accounted for.

More specifically, layer (a) 20 may comprise one or more layers of suitable materials selected from the group consisting of plywood, oriented strand-board (OSB), plastic, metal, or various boards made with a high proportion of cementitious or mineral materials in their oxidized form such as Magnesium Oxide (MGO) or mineral materials in their unreacted form such as gypsum.

Referring to FIG. 1b, preferably layer (a) 20 is reinforced with fiber 50 where the fiber is chosen for its strength, durability and cost.

Preferably, the fiber reinforcement 50 is fiberglass woven in one or more directions, and/or in one or more planes to impart strength to the reinforced sheet in two or more directions.

Preferably, referring to FIG. 1b, layer (a) 20 comprises fiber reinforcement 50 and plastic 55 where the resin used to make the plastic is chosen to be impervious to moisture and degradation caused by mold and ultra violet radiation.

Preferably, the plastic resin comprises phenolic compounds with properties that are advantageous to the inhabitants in the presence of heat and/or fire.

Referring to FIG. 1c, preferably, layer (a) 20 is punctuated with one or more apertures 60 of any shape or distribution to allow moisture to diffuse outwards.

Layer (b) may comprise one or more layers of expanded or foamed materials selected from the group consisting of polystyrene (PS), polyurethane (PUR), polyisocyanurate (PIR), polyethylene terephthalate (PET), polyvinyl chloride (PVC), and various fibrous materials such as glass wool or mineral wool, as well as Vacuum Insulated Panels (VIP's) of any kind.

Referring to FIG. 1d, in a preferred embodiment, layer (b) 30 is sandwiched on one or both faces by expanded or foamed thermoset materials 62a and/or 62b with known insulating and structural properties.

Preferably, layer 62a and/or layer 62b are enhanced using a modified polyurethane resin known as Polyisocyanurate (PIR) which leads to a high level of resistance to heat flow relative to other insulation types, resulting in a composite panel that is optimal with respect to thermal, fire and structural performance at a minimum of thickness.

Preferably, layer 61, disposed towards the middle of the sandwiched composite panel 30, is comprised of Polystyrene (PS) material with suitable structural properties. It is known that polystyrene type foam is more cost effective but less heat and fire resistant than thermoset foam.

Polystyrene type foam is also known to be readily cut by hot wire without producing obnoxious fumes, thereby facilitating edge profiling within layer 61 in order to create suitable voids on any of the perimeter faces of the composite panel which may be needed to locate seals, splines or other structural elements depending on the location and purpose of the composite panel.

In a preferred embodiment, layer (b) 30 comprises a PS layer 61 sandwiched between two PIR layers 62a & 62b.

Preferably, layer (b) 30 is sandwiched on one or both faces by expanded or foamed thermoset materials 62a and/or 62b with properties that are advantageous to the inhabitants in the presence of heat and/or fire.

Similar to layer (a) 20, layer (c) 40 may comprise one or more layers of suitable material selected from the group consisting of plywood, oriented strand-board (OSB), plastic, metal, or various boards made with a high proportion of cementitious materials or mineral materials in their oxidized form such as Magnesium Oxide (MGO) or mineral materials in their unreacted form such as gypsum.

In a preferred embodiment, layer (c) 40 is reinforced with fiber 50 where the fiber is chosen for its strength, durability and cost.

Preferably, fiber reinforcement 50 is fiberglass woven in one or more directions, and/or in one or more planes to impart strength to the reinforced sheet in two or more directions.

Preferably, layer (c) 40 comprises fiber reinforcement 50 and plastic 55 where the resin used to make the plastic is chosen to be impervious to moisture and degradation caused by mold and ultra violet radiation.

Preferably, the plastic resin comprises phenolic compounds with properties that are advantageous to the inhabitants in the presence of heat and/or fire.

Referring to FIG. 1e, preferably, layer 30 is punctuated with one or more apertures 63 of any shape or distribution, where such apertures are in communication 64 with one or more apertures 60 in layer (a), in order to promote the diffusion of moisture outwards.

Referring to FIG. 1f, the composite panel may further comprise layer (d) 70 with properties that are advantageous in the presence of heat and/or fire, wherein said layer (d) is located:
(1) between layers (a) and (b), as 70a,
(2) between layers (b) and (c), as 70b, or
(3) between both layer (a) and (b) and layers (b) and (c), as 70a and 70b.

Preferably, layer (d), 70a and 70(b), comprises an inorganic coated fibrous mat or “slip sheet” which is generally known in the roofing trade to be fire resistant and beneficial for the separation of non-compatible materials.

Preferably, layer (d) comprises a “slip sheet” where the fiber is chosen for its strength, durability and cost.

Preferably, layer (d) comprises fiber that is woven in one or more directions, and/or in one or more planes, in order to impart strength to the reinforced sheet in two or more directions.

Preferably, layer (d) imparts additional strength to the overall composite panel because of its location within the panel.

Preferably, layer (d) comprises a “slip sheet” is made of inorganic material where the inorganic material is largely comprised of aluminum trihydrate, in order to impart additional fire resistance to the composite panel through the action of absorbing heat to release molecularly bound water.

Preferably, layer (d) comprises a “slip sheet” that imparts a physical barrier that permits the use of less expensive Polystyrene (PS) insulation on one side of the barrier and another type of insulation that is sensitive to PS vapours on the other side of the barrier.

Referring to FIG. 1g, in a preferred embodiment, a slip sheet 70a and/or 70b may be inserted between the PS layer 61 and the PIR layer 62a and/or the PS layer 61 and the PIR layer 62b.

In another preferred embodiment, a slip sheet 70a or 70b may also be inserted in between adjacent or abutting composite panels.

In a preferred embodiment of an economical version of composite panel 10, the use of two such barriers enveloping layer (b) 30 made from a sheet of Polystyrene (PS) insulation in order to save costs while still providing a measure of fire resistance to the panel, because such slip sheets 70aand 70b are less expensive than layers 62a and 62b made from PIR type insulation.

Referring to FIG. 1h, in another preferred embodiment, a Vacuum Insulated Panel (VIP) or Vacuum Insulated product 71a and/or 71b of any kind may be located near the outer surface of layer (a) 20, preferably on the exterior, or alternatively located near the inner surface of layer (a) 20 (not shown), by any means suitable, including detachable means.

Preferably, the means of securing such VIP envelops said VIP or Vacuum Insulated product 71a and/or 71b within a protective layer 72 acting as both a carrier and a means of protection for the VIP.

Preferably, the layer 72 acting as a carrier for the VIP is not attached to the VIP so to allow differential movement between the VIP so encapsulated and the surrounding material of the panel, to avoid stressing the VIP and to improve its longevity.

Preferably, removable fasteners of any kind 73 are used to attach the VIP by piercing the carrier only, through to and including as a minimum layer (a) 20, thus binding the VIP to the composite panel while preserving the integrity of the VIP and allowing for its replacement should the VIP panel fail to maintain a vacuum for any reason during its life cycle.

Referring to FIG. 1i, in a preferred embodiment, a composite panel is strengthened by additional layer(s) (e), wherein said layer (e) is located:
(1) between layer (d) 70a and layer (b) 30, as 75a;
(2) between layer (b) 30 and layer (d) 70b, as 75b; or
(3) between layer (d) 70a and layer (b) 30, and between layer (d) 70a and layer (b) 30, as 75a and 75b;
wherein layer (e) in the form of 75a and/or 75b is disposed towards the middle of the composite panel, formed by lamination of one or more sheets of screened material 75a and/or 75b to the core layer (b) 30.

Preferably, the screen material 75a and/or 75b is made using a fiber chosen for its strength, durability and cost.

Preferably, the fibrous screen material 75a and/or 75b is woven in at least two directions.

Preferably, the woven fibrous screen material 75a and/or 75b is made rigid by its impregnation with plastic material.

Preferably, the resin used for making the plastic comprises phenolic compounds in order to impart resistance to water, mold, UV degradation, heat and fire.

Referring yet again to FIG. 1i, the foam used for the core layer (b) 30 may be any material of suitable strength for the purpose.

Lamination may be performed by known method(s) of adhering the screens 75a and/or 75b to a foam slab already made.

Preferably, the lamination is performed by restraining the two screens in a jig or fixture and applying the unexpanded foam within the void in between the two screens 75a and/or 75b in such a way that when the foam expands it adheres to the increased surface area of the two screens presented to the core layer 30 once it is almost fully expanded, causing the foam to permeate the cross section of the screens 75a and/or 75b.

In another preferred embodiment, the composite panel as described above is made using a screen material made of metal in order to impart additional strength to resist vandalism or ballistic projectiles.

Referring yet again to FIG. 1f, in another preferred embodiment, a composite panel is constructed with layer(s) (d) 70a and or 70b disposed towards the exterior and/or interior of the composite panel, where layer (b) 30 is formed by expanding a structural grade of thermoset foam within one or two inorganic coated fibrous mats or “slip sheets”, to effect economical and reliable bonding without the additional step of applying an adhesive during this stage of the assembly of the composite panel. It is known that a thermoset resin foam forms by its very nature a self-insulating char layer upon exposure to fire, thereby further increasing the resistance of the composite panel to heat and fire.

Preferably, layer (d) is adjoined across composite panel seams by intumescent fire retardant materials in order to provide continuity of fire protection means across composite panel seams.

A preferred composite panel constructed more economically when facing fire from within the structure only, without layer 70a disposed adjacent to layer (a) 20 of the composite panel, where the core layer (b) 30, disposed towards the middle of the composite panel, is comprised of Polystyrene (PS) material.

Preferably, said PS material has sufficient water vapour permeance to ventilate moisture in the core layer (b) 30 outwards to layer (a) 20, where said permeance acts alone or in communication with the apertures 60 in layer (a) and the apertures 63 in layer (b) to allow moisture to diffuse outwards from the composite panel.

Preferably, moisture present by any means within the core layer (b) 30 is ventilated outwards to the outer layer (a) 20 with the assistance of one or more of the apertures 63 in the core layer (b) created by any means within the core layer (b) 30 where said apertures act alone or in communication 64 with one or more of the apertures 60 in layer (a) to allow moisture to diffuse outwards from and through the building envelope.

Referring to FIG. 1j, preferably, a weather-resistant cladding 80 is present towards the exterior of the composite panel.

Preferably, the cladding 80 is affixed through spacers 81 using removable fasteners 82 that bind through the cladding, spacer and into layer (a) 20 as a minimum.

Preferably, the VIP or Vacuum Insulated product 71a and/or 71b as shown in FIG. 1h may be inserted anywhere between the outer layer (a) 20 and the cladding 80. More preferably, in such a case, the layer 72 acting as a carrier for the VIP comprises mineral wool material.

Preferably, cladding 80, when present and in close proximity to the outer layer (a) 20, is provided with apertures 83, where said apertures are in communication 84 with one or more ventilation means described above within the core layer (b) 30 and the outer layer (a) 20 (apertures 63 which are in communication 64 with one or more apertures 60) to allow moisture to diffuse outwards from and through the building envelope.

Preferably, cladding 80 is provided with a profile of any kind, optionally with a spacer to create a gap that enhances the free movement of moisture out towards the cladding 80.

Preferably, said gap exhibit properties of a ventilated façade.

Preferably, the cladding 80, if corrugated, is provided with apertures 83 disposed on the web portions only.

Referring to FIG. 1k, layer 61 may be profiled by any profiling means, when layer 61 is made of polystyrene, an economic and convenient method of profiling is using a hot wire to provide edge profile 85 for later receiving structural columns and/or compressible seals.

Referring yet again to FIG. 1d, preferably, the density of layer 61 is less than or equal to the density of layer 62a or 62b because of the higher level of shear stress in layer 62a or 62b, as would generally be understood by a person skilled in the art.

Preferably, layer 61 is made less than 6 inches in thickness using a density of foam equal or less than 2 lbs per cubic foot.

Preferably, layer 61 is adhered to adjacent layer(s) 62a or 62b which are made using a density of foam equal to or greater than 2 lbs per cubic foot.

Preferably, the adjacent layer(s) 62a or 62b are made between ½ an inch and 4 inches in thickness, and more preferably, between 2 and 3 inches in thickness.

Referring yet again to FIGS. 1f and 1g, preferably, the inorganic coated fibrous mat(s) or “slip sheet(s)” 70a or 70b used to form or bound layer(s) (d) is/are smooth to promote the sparing use of suitable adhesives.

Suitable adhesives comprise heat-activated adhesives, water-activated polyurethane adhesives, two component polyurethanes or epoxy type adhesives of any kind.

A further preferred embodiment where the adhesive used to attach the various layers used in the composite panel is chosen to be an easy to apply, low odour and safe to handle two component epoxy with long pot life, thereby allowing a generous time period to hand-lay the composite panel together.

Preferably, the epoxy chosen does not require elaborate quality control means such as preheating, post heat treatment, or finely controlled time and pressure protocols.

Preferably, code approved commodity type sheets goods and-or panels are assembled locally or on-site with relatively little attention to quality control due to the nature of epoxy adhesives used in order to involve the local community in the assembly of the composite panels used for the construction of the structure.

### Add-Ons to Composite Panels

When building rapidly deployable housing, there are parts, referred to as “add-ons” that can be added to the composite panels as described below.

Flanges

Flanges may be provided as an add-on to a composite panel in order to bind adjacent composite panels to each other.

Referring to FIG. 2a, flanges may be formed or attached to by any means along the edge(s) of layer (a) 20, layer (c) 40, or both.

Preferably, flanges may be formed or attached adjacent to any portion of the perimeter edges of the composite panel.

Preferably, flanges are disposed in any combination of layers, edge location or edge coverage, in order to bind adjacent composite panels to each other.

Preferably, flanges are configured to seal out weather, limit moisture migration and maintain building integrity under the influence of climatic conditions such as wind and seismic events.

A person skilled in the art would understand that flanges may not necessarily need to be attached to all perimeter edges of both layer (a) 20 and layer (c) 40 of a composite panel. Rather, wherever used, they need to be arranged as opposed pairs that cross the seam formed between adjacent composite panels.

Preferably, flat sheet A and flat sheet B (100a and 100b) as shown in FIG. 2a are roll formed from light gage sheet metal with at least one bend line 110a in sheet A and bend line 110b in a separate sheet B which is later placed adjacent to sheet A. This can be done economically using techniques known in the ducting trade.

Preferably, when adjoining flat sheets A and B are bent away from the interior of the composite panel in a generally “L” shaped form respectively, shown as flanges 140a and 140b in FIG. 2b respectively, and attached to the outer layer (a) 20 and/or inner layer (c) 40, the bent portions of flanges 140a and 140b may be brought together by binding means to bind the adjacent composite panels.

Preferably, the flanges 140a and 140b are attached to the respective composite panel using fasteners 150a and 150b affixed through the flange and at least through layer (a) 20 or layer (c) 40, as the case may be. Such fastening means may be, for example, screws, bolts, rivets and pinch and/or pierce locking methods of any kind.

A person skilled in the art would understand that flat sheets A and B (100a and 100b) may be bent at any angles. Preferably, flat sheets A and B (100a and 100b) are bent at similar or the same angles, so that bent sheets A and B, now flanges 140a and 140b with the bent vertical faces 141a and 141b, respectively, are mirror images of each other. Preferably, flat sheets A and B (100a and 100b) are bent vertically at about 90 degree angles as shown in FIG. 2b.

Referring to FIG. 2c, preferably, bent vertical faces 141a and 141b may further comprise reciprocal apertures 120 and protrusions 130 in sheet A and/or sheet B located as opposite pairs so that said protrusions 130 and apertures 120 mate when the adjoining sheets A and B are bent as flanges 140a and 140b respectively and the flanges are drawn close together.

It can be readily understood by one practiced in the art that such apertures 120 and protrusions 130 may each be of any shape as long as the protrusion 120 fits easily into the aperture 130 and the protrusion is bounded or restrained from movement along the flange longitudinally and or laterally.

Furthermore, the distribution of apertures 120 and protrusions 130 may be in any arrangement or any distribution on the bent vertical faces 141a and 141b, providing any coverage of the bent vertical faces 141a and 141b resulting in flange areas 135a and 135b, which are areas of the bent vertical faces 141a and 141b minus apertures 120 and protrusions 130.

Preferably, such flange areas 135a and 135b abut to each other when vertical faces 141a and 141b are drawn together, such abutment being useful as a positive stop when flanges 140a and 140b are brought together, thereby ensuring the mating of opposed pairs of apertures 120 and protrusions 130. Furthermore, such abutment allows for the proper engagement of the panels as a system, because panel dimensions are defined at the abutting edges.

Referring to FIG. 2d, preferably, said apertures 120 are generally rectangular and formed by any means within the light gage sheet metal before roll forming.

Preferably, said protrusions 130 are generally rectangular and are formed during the roll forming process thus economizing on their manufacture.

Preferably, said apertures 120 and protrusions 130 mate when the vertical faces 141a and 141b are brought together across the abutting face 160 that exists between the abutting flanges 140a and 140b.

Preferably, said face 160 comprises at least some flat area 135a and 135b in order to provide a further positive stop for the engagement of the protrusions 130 and apertures 120.

Referring again to FIG. 2d, preferably, the distribution of apertures 120 and protrusions 130 alternates in the longitudinal direction of the vertical faces 141a and 141b as shown.

Preferably, such alternation is continual (as shown) so that protrusions 130 coming from vertical face 141a are in close contact with protrusions 130 coming from vertical face 141b at one or more locations on plane 160 when the vertical face 141a and 141b are brought together.

Referring again to FIG. 2d, preferably, one of the flange parts so made is positioned such that it is translated along the opposite flange face as shown at 162, such that the two flange faces can be made identical and staggered on installation, or otherwise optimized to be nearly identical, eliminating the material placement shown at 161 in order to economize on the manufacture of flanges.

Referring to FIG. 2e, preferably, vertical faces 141a and 141b may further comprise a lower closure strip 170a and 170b, which is the area between the bend line 110a and the apertures 120 or protrusions 130 as the case may be.

Referring again to FIG. 2e, preferably, flange areas 135a and 135b may further comprise an upper closure strip 180a and 180b and between the outer extremity of the vertical faces 141a and 141b and the apertures 120 or protrusions 130 as the case may be.

Preferably, the lower closure strips 170a and 170b abut when the vertical faces 141a and 141b are brought together, so as to form a positive stop which ensures the proper mating of protrusions 130 and apertures 120.

Preferably, the upper closure strips 180a and 180b abut when vertical faces 141a and 141b are brought together, so as to form a second positive stop which ensures the proper mating of protrusions 130 and apertures 120.

Preferably, said abutments are located on plane 160 which is located between the vertical faces 141a and 141b of the flanges 140a and 140b at the seams between adjacent composite panels.

It can now be readily understood by one practiced in the art the abutment of lower closure strips 170a and 170b, and/or upper 180a and 180b provide an additional positive stop feature useful for limiting the approach of composite panels across their seams.

Preferably, the use of upper closure strips 180a and 180b contribute to strengthening the protrusions by connecting their upper extremities, thus increasing the shear transfer potential of mating apertures 120 and protrusions 130 particularly in the longitudinal dimension of vertical faces 141a and 141b of the mated flanges 140a and 140b.

A person skilled in the art would understand that the lower closure strip 170a and 170b, the upper closure strip 180a and 180b, may be present alone or together in the vertical faces 141a and 141b of flanges 140a and 140b.

Referring to FIG. 2f, preferably, the abutting faces of the lower closure strips 170a and 170b are located close to the plane 160 when the vertical faces 141a and 141b of the flanges are pushed together, which is useful for the addition of sealant 195 by any means, thus creating a compliant seal along a part of the flange most resistant to deformation when the vertical faces of the flanges are brought together across the seam formed between adjacent composite panels.

Preferably, the sealant 195 is pinched by the action of drawing the flanges together across the seam between adjacent composite panels, which creates a continuous linear seal arranged longitudinally between the vertical faces 141a and 141b of flanges 140a and 140b, said seal being useful for limiting the travel of moisture or wind through the seam between adjacent composite panels.

Preferably, said sealant 195 has intumescent properties to assist with resisting the effects of heat and fire entering the seam area located between adjacent composite panels.

Preferably, the vertical faces 141a and 141b of flanges 140a and 140b of the adjacent composite panels may be brought together and secured for engagement by any means, for example, by any fastening or binding means across the flanges 140a and 140b and/or the longitudinal insertion of a pin into the generally circular void 196 created between adjacent protrusions when viewed longitudinally along the vertical faces 141a and 141b, as would generally be understood to be a type of hinge pin securing means.

Cleat

Self-securing fastening means which do not require the use of tools and can be handled by gloved hands even in unfavorable weather conditions are preferred.

Further, standardized and easily portable fastening means are preferred to reduce the parts needed to be transported to remote areas, and improve the speed of fastening.

In a preferred embodiment, a cleat, a standardized and easily transportable and removable fastening means, is used to bring together flanges 140a and 140b of the adjacent composite panels.

Referring to FIG. 2g, preferably, the flanges 140a and 140b are brought together and secured by the action of a removable cleat 200 which is inserted longitudinally along the outer edge(s) of the flanges.

A person skilled in the art would understand that a removable cleat may be used to fasten any of the embodiments of flanges 140a and 140b, for example, with no apertures and protrusions, with apertures and protrusions, with lower closure strip, with upper closure strip and any combination thereof.

Preferably, flanges 140a and 140b also bear an additional bend line 205a and 205b respectively, which are substantially perpendicular to the abutting face of 160 to create a flat portion 210a and 210b respectively at the outer extremity of the flange as shown in FIG. 2g.

Preferably, this additional bend is approximately 90 degrees relative to the rest of the flange while preserving the abutting areas of upper closure strip 180a and 180b shown in FIG. 2g.

Preferably, a “c” shaped cleat 200 as shown in FIG. 2g is also formed by roll forming light gage sheet metal using techniques known in the ducting trade.

Preferably, the cleat 200 is broken into lengths of convenience being about 3 feet long so that the cleat can be slid easily but securely onto the adjoining flanges when they are brought hard up against the stopping faces.

Preferably, the action of sliding the cleat longitudinally onto the vertical faces of the flanges brings the flanges close together as part of the binding process.

Preferably, the dimensioning of 140a and 140b and the width of cleat 200 shown in FIG. 2g will be such that it will draw the upper closure strip 180a and 180b together. This in combination with the action of sliding on the cleat 200 deforms the flanges 140a and 140b slightly, drawing the upper closure strip 180a and 180b shown in FIG. 2b closer together because of the space occupied by the sealant 195, resulting in a stronger pinching of the sealant 195 making for an improved seal in this area.

Preferably, the interaction of 140a and 140b and cleat 200 in FIG. 2g and the stopping face areas created by the bringing together of the lower closure strip 170a and 170b and the upper closure strip of 180a and 180b shown in FIG. 2h, with or without the use of sealant 195, serves to bind adjacent composite panels together across their abutting seams by the following additive means:
1) Resisting shear transfer along the longitudinal dimension of the flanges 140a and 140b between adjacent composite panels; and
2) Resisting separation along the lateral dimension of the flanges 140a and 140b between adjacent composite panels.

In a preferred embodiment, the flange faces are readily engaged or disengaged by addition or removal of the cleat, to effect panel replacement, repair or alteration without the use of traditional fasteners such as screws or bolts which would require tools.

Preferably, the flanges are disposed to allow composite panel assemblies (for example: the floor pan, the roof pan, each planar wall of the structure) to act in unison through the transfer of forces in order to properly absorb and transmit wind and seismic loads throughout the structure as is required for maintaining building integrity, as would readily be understood by one skilled in the art.

Preferably, the flanges and cleats used are made of a grade of steel suitable for structural purposes.

Preferably, the flanges and cleats used are made from a grade of steel resistant to the effects of corrosion or fire, or alternatively made from a grade of steel resistant to the effects of fire and treated for corrosion protection by any means.

Preferably, the cleat is free to expand along its length under the effects of heat and fire so as to maintain the integrity of the flange to flange connection.

Preferably, the flanges and cleats used are made of a low alloy Corten™ type of steel or stainless steel.

Lining

In a preferred embodiment, there is an additional layer of material, referred to as lining, extended to cover in part or full the flanges, the composite panel, or both.

Referring to FIG. 2h, preferably, lining 220a and 220b is added along the vertical height of flanges to provide additional fire resistance for the composite panels and when extended beyond the flange area to present a fire resistant and user-friendly surface on the interior of the building.

Preferably, lining 220a and 220b is attached to the composite panel in the factory using removable mechanical fasteners 230a and 230b that are resistant to the effects of heat and fire.

Preferably, said removable mechanical fasteners 230a and 230b further comprise or bear an enlarged head 240a and 240b that helps secure lining 220a and 220b.

Preferably, said enlarged head 240a and 240b is made of a grade of steel resistant to the effects of heat and fire.

Preferably, said removable fasteners 230a and 230b bear through lining 220a and 220b and through inner layer (c) as a minimum.

Preferably, lining 220a and 220b as shown in FIG. 2h is made of lightweight, durable, mold resistant, non-combustible and/or fire-resistant material.

Preferably, lining 220a and 220b is made of materials with high proportion of recycled cellulose fiber in order to enhance sustainability.

Preferably, lining 220a and 220b further comprises an active heat-resistant ingredient such as gypsum or aluminum trihydrate.

Preferably, lining 220a and 220b is made of material with properties uniform throughout in order to minimize the reduction of fire resistance when damaged.

Preferably, lining 220a and 220b can absorb and desorb moisture present within the building envelope in order to buffer and stabilize the presence of moisture within the building thereby minimizing moisture condensation on the interior of the building, especially in cold climates.

Preferably, lining 220a and 220b can be stained for appearance without compromising its ability related to absorption and desorption of moisture.

Preferably, lining 220a and 220b is made of Homasote™ material, which is known to have the above properties and is lighter than competing products.

Preferably, lining 220a and 220b fits snugly to the underside of the cleat 200 once the cleat is installed.

Preferably, lining 220a and 220b as shown in FIG. 2g exhibits a degree of insulating effect in order to limit heat flow into the composite panel seam area, for example, during fires.

Preferably, the so described flanges and cleat form a robust barrier that resists the effects of heat and fire penetrating past the additional lining 220a and 220b as shown in FIG. 2g, thereby limiting the chances of involving the inner region of the composite panel in a fire.

Preferably, the so described cleat forms a field finishing technique that relies on mechanical action only and does not require enclosing and or preheating of the building as would be the case with standard fire rated field joints made between traditional gypsum based products used for the interior surface of the building.

Outer Cladding

Referring to FIG. 2i, preferably, exterior material is added at 250a and 250b (which is outside of outer layer (a) 20) to provide additional weather protection for the composite panels and to present a user-friendly surface on the exterior of the building.

Preferably, said exterior material is added to the composite panel in the factory using removable mechanical fasteners 255a and 255b that are resistant to the effects of corrosion.

Preferably, said mechanical fasteners 255a and 255b bear through material 250a and 250b, then optionally a spacer material 81 (81a and 81b), and on through outer layer (a) 20 as a minimum.

Preferably, the exterior material added 250a and 250b as shown in FIG. 2i comprises a type of material generally described as cladding (80) as shown in FIG. 1j.

Preferably, said cladding is corrugated for strength. For example, corrugated cladding may be used on the exterior of composite panels that are used for the roof, floor or exterior perimeter wall(s) of a housing structure.

The corrugated cladding may be made of any durable material, such as metal or plastic.

Preferably, the material used is aluminum or aluminum alloy or thin gage steel or steel alloy protected by zinc and/or aluminum and/or paint in any combination.

Preferably, the material used for at least a portion of the web of the cladding is ventilated by a multitude of apertures 83a made using any suitable method.

Preferably, the apertures shown at 83a are made by water jets and/or punching when thin gage steel protected by zinc and-or aluminum is used, such that the protection layer continues to act to protect the perimeter of the web apertures by galvanic action even though the apertures were made after the protective coatings were applied.

Preferably, the apertures shown at 83b are made economically by opposed punching to relieve a small section of material so that the relief material is angled in such a way to minimize the penetration of wind borne moisture into the ventilated space beneath the exterior cladding.

Preferably, the seams between composite panels are sealed on the exterior of the building using a removable seal 270.

The seal may be attached to the exterior material 250a and 250b (for example, cladding 80) by fastening means.

Preferably, said removable seal 270 is made into a double corded strap with longitudinal edges 280a and 280b that are flexible and fit snugly into Keder type receiving channels 290a and 290b respectively. Keder type receiving channels 290a and 290b may be fastened inside or outside to exterior material 250a and 250b (for example, cladding 80) by any fastening means for example, 300a and 300b respectively.

Preferably, the Keder type receiving channels 290a and 290b are corrosion resistant and affixed and sealed to the exterior material 250a and 250b (for example, cladding 80) to prevent entry of windblown moisture to the underside of the ventilated exterior material 250a and 250b (for example, cladding 80).

Preferably, the removable seal 270 made into a double corded strap is durable and resistant when exposed for long periods to sunshine, wind and moisture of all kinds.

Preferably the removable seal 270 made into a double corded strap protects the composite panel flanges from the direct effect of wind pressure, allowing any moisture that is present beneath the cladding to either dissipate or to drain, thus ensuring that the building can dry outwards under the moisture gradient present form inside to outside for inhabited buildings exposed to arctic conditions, thus preventing the formation of mold within the composite panels used for the building envelope.

### Building Structural System

According to the present invention, the building structural system consists of a set of repeating structural elements, which in communication with each other and the building envelope made of composite panels, provide for the collection and transfer of structural loads to the base of the building that rests upon the ground.

Such structural loads include but are not limited to, loads caused by the weights of materials used in the construction of the building, loads caused by the contents of the building, predominantly static loads placed upon the building by the forces of nature such as wind, rain and snow and more dynamic loads caused by the interaction of the building with seismic forces and ground settlements caused by any means.

According to the present invention, there are one or more of the following principal repeating elements used for the building structural system:
a 1-D assembly that is a “transom” (structural beam) that arrives in the field ready for use, i.e., a 1-D transom;
a 1-D assembly that is a “column” that arrives in the field ready for use, i.e., a 1-D column;
a 2-D assembly that is a “rectangular” lattice or truss that arrives in the field ready for use; i.e., a 2-D rectangular lattice;
a 2-D assembly that is a “triangular” lattice or truss that is assembled in the field; i.e., a 2-D triangular lattice; and
a 1-D assembly that is a “pier” that arrives in the field ready for use; i.e., a 1-D pier.

As described herein below, the floor composite panels acting in unison, the roof composite panels acting in unison and the wall composite panels acting in unison, will also communicate advantageously with the building structural system once the composite panels are connected to each other by the flanges and/or cleats as previously described.

The above repeating elements of the building structural system will now be described in an order that is helpful to understanding the invention.

2-D Rectangular Lattice

The 2-D rectangular lattice functions as a repeating element of the building structural system.

The dimensions of the 2-D rectangular lattice establish the principal repeating dimensions of the 2-D cell structure that governs the arrangement of the building structural system.

In a preferred embodiment, this repeating 2-D cell structure is used both in the floor support which supports the floor composite panels and in the roof support which supports the roof composite panels as described hereinafter, creating an economy of parts and advantages in various alignment arrangements.

Preferably, each individual 2-D rectangular lattice is of common dimensions, made under factory-controlled conditions and arrives in the field ready to use. This does not preclude the use of 2-D rectangular lattice of various dimensions, to suit special building requirements, as would be understood by a person skilled in the art.

Preferably, the overall length and width of the 2-D rectangular lattice is chosen to accommodate the principle dimensions of applicable air transport pallets. Such constraints could limit the dimensions of the repeating cell structure to less than about 8.5 ft, which would dictate the length of the 2-D rectangular lattice but not necessarily the width as would be understood by a person skilled in the art.

Referring to FIG. 3a, 2-D rectangular lattice 300a, 300b, 300c, and 300d, connected by 1-D piers 600 which will be described herein under, form a building unit 310 for the floor support and/or a building unit 320 for the roof support of the building structure.

Preferably, viewing from the top, each of building unit 310 for the floor support and/or a building unit 320 is a square.

Preferably, the 2-D rectangular lattices 300a, 300b, 300c, and 300d are dimensionally equivalent and optimized to accommodate transportation on air pallets.

Preferably, the dimensions of the 2-D rectangular lattices 300a, 300b, 300c, and 300d used in the floor support and the roof support are equivalent, which allows alignment 330 of the building unit 310 for the floor support and building unit 320 for roof support, which will be exploited later for interconnection of these two structures.

Referring to FIG. 3b, a side view of the 2-D rectangular lattice 300a (300b, 300c, or 300d), the 2-D rectangular lattices 300a, 300b, 300c, and 300d is a predominantly planar structure that consists of tubes and/or plate formed elements welded together using known means.

Preferably, the 2-D rectangular lattice 300a (300b, 300c, or 300d) bears a receiving means 345 at midpoint of the top of said 2-D rectangular lattice when said lattice is placed vertically. Said receiving means are to receive a transom-hub connector which will be described herein under.

To connect the 2-D rectangular lattices 300a, 300b, 300c, and 300d to the rest of the building structural system (for example, 1-D piers 600), preferably, the 2-D rectangular lattice 300a, (300b, 300c, or 300d) bears tubular connecting assembly 340 at the four corners of said 2-D rectangular lattice as shown in FIG. 3b.

Referring to FIG. 3c, a side view of the tubular connecting assembly 340, preferably, the tubular connecting assembly 340 comprises a tubular element 350. Said tubular element 350 bears a pair of holes 360 (360a and 360b), aligned in any orientation relative to the tubular element 350, for receiving a removable pin 370 of any kind. The pin 370 may further transect with an object 380 placed inside the tubular element 350, wherein said object 380 is connected to the rest of the building structure (for example, 1-D piers 600).

Preferably, the pair of holes 360a and 360b drilled for each of the pin 370 as required is provided using precise and repeatable means such as offered when using a jig or fixture in the manufacturing process in order to control the tolerances of the fit up of the repeating cell structure of the building structural system.

FIG. 3d is an illustrative and non-limiting example for a welded design of the 2-D rectangular lattice.

Preferably, the 2-D rectangular lattice is built up using welds applied to tubes with close fitting coped ends as would be familiar to a person skilled in the art.

Preferably, the welding is performed while the tubes are mounted in a fixture to align and restrain the tubes while the welding operation is underway as would be familiar to a person skilled in the art.

Horizontal tubes 400a and 400b which form the 2-D rectangular lattice may be circular in cross section both internally and externally and may be larger in diameter than the other tubes as described herein under. Preferably, the outside diameter is 4 inches or less than.

Vertical tubes 410a, 410b and 410c which form the 2-D rectangular lattice may be circular in cross section both internally and externally and may be smaller in diameter than the other tubes.

Preferably, the outside diameter is 1 inch or more.

Tubular elements as described above 350a, 350b, 350c and 350d which form the so called tubular connecting assembly 340 may be circular in cross section both internally and externally and may be larger in diameter and/or thicker than tubes 400a and 400b, such extra thickness making up for both the loss of strength that occurs when tubular elements 350a, 350b, 350c and 350d are welded to tubes 410a and 410b and the loss of strength that occurs by the provision of holes 360 made to receive removable pins 370 that are used to secure the 2-D rectangular lattice to the building structural system.

Preferably, the horizontal length of each of the 2-D rectangular lattice is less than about 8.5 feet for ease of transport by air.

Preferably, the vertical height of each of the 2-D rectangular lattice is less than 3 feet resulting in at least two so called “bays” within the lattice as shown on FIG. 3d and would be understood by one skilled in the art of truss design.

Preferably, tube 410c is positioned mid span in order to bear point loads which will be described later.

Preferably, diagonal tubes 420a and 420b, which together formed a V shape anchored near the mid-span of 400b to further strengthen the load-bearing capacity of the 2-D rectangular lattice. It will be understood by a person skilled in the art of truss design that tubes 420a and 420b are generally in tension when acted upon by point loads to be applied at the mid-span of 400a which is economical but does not preclude the positioning of tubes 420a and 420b to form an inverted V shape if necessary.

Referring to FIG. 3e, preferably, tubular connecting assembly 350 bears an internal profile 430 formed by any means oriented so as to provide more material where the opposed holes are provided in order to receive removable pins that are used to secure the 2-D rectangular lattice to the building structural system.

Referring to FIG. 3f, preferably, horizontal tubes 400a and 400b bear an internal profile 440 formed by any means oriented so as to provide more material at the top and bottom in order to minimize the loss of strength that occurs during welding operations while positioning more relatively more material at the upper most and bottom most extremities of the vertical height of the 2-D rectangular lattice.

Preferably, the internal profiles at 430 and 440 are made economically by extrusion when the tubing is formed.

Preferably, the internal profile created by extrusion is more rectangular than round, which proportions relatively more material where it is needed most in the construction, allowing for less material to be used overall, thus economizing the selection while maintaining adequate strength overall.

FIG. 3g is another illustrative and non-limiting example for a welded design of the 2-D rectangular lattice.

In this example, aspects of the first non-limiting example are retained (for example, horizontal tube and tubular connecting assembly 340) except for the construction of the vertical elements, the so called “web”, which is described below.

Preferably, the elements which comprise the so called “web” are made from open or closed forms that facilitate the use of predominantly linear welds used to connect the “web” elements to themselves and to the 2-D rectangular lattice in general, such welding being economical because it is easy to automate, as would be understood by one skilled in the art.

Referring to FIG. 3g, preferably, the webs elements 410a, 410b, 420a, 420b, 420c and 420d of the 2-D lattice may be made from bent plate or rectangular tubes.

Preferably, the material used for the web elements is lightweight aluminum or aluminum which allows for compatibility when welding to the other elements of the 2-D rectangular lattice.

Preferably, the diagonal elements of the web are “X-shaped” to add strength to the 2-D rectangular lattice because of the ability of the “X-Shape” to bear both tension and compression loads that may be present in the web elements.

Preferably, the “X-Shaped” web elements feature opposed bent edges when viewed at any cross section in order to create a “Z-shaped” profile in order to impart strength and a tendency to resist buckling under pressure.

Preferably, both elements of the “X-shaped” web are made from identical parts so to economize on manufacturing.

Preferably, both elements of the “X-shaped” web are joined at the center 450a, 450b by any means to impart further stability to the 2-D lattice.

Preferably, web elements 410a, 410b and 410c bear closed form shapes of any kind in order to assist the 2-D rectangular lattice in the transference of vertical loads within the web and moments at the four extremities of the 2-D rectangular lattice.

Preferably, the extremities of the web elements so described are joined to the 2-D rectangular lattice near the centerline of the respective horizontal tubes by a weld that is predominantly linear, in order to economize on manufacturing operations.

Preferably, the portion of the tube bearing the weld at the extremity of the web elements is thicker than the rest of the tube in order to minimize the reduction of strength due to welding.

FIG. 3h is a further illustrative and non-limiting example for a hybrid of welded and non-welded design of the 2-D rectangular lattice.

In this example, aspects of the first and second non-limiting example are retained (for example, horizontal tube and tubular connecting assembly), except for the elements described below.

Preferably, horizontal tubes 400a and 400b are lightweight tubes with a circular cross section inside and out. Preferably, they are made from lightweight aluminum, aluminum alloy or corrosion protected steel.

Preferably, web elements 410a, 410c, 350a, 350b, 350c, 350d are lightweight tubes with circular cross section inside and out. Preferably, they are made from lightweight aluminum or aluminum alloy.

Preferably, the extremities of elements 410a, 410c and 350b and 350c are coped to a close fit and welded to the adjacent aluminum component in the factory.

Preferably, element 420a and 420c are lightweight tubes with circular cross section inside and out. Preferably, they are made from lightweight aluminum, aluminum alloy or corrosion protected steel. Preferably, they bear press formed ends with pin holes suitably located to receive pins 460 as shown.

Now it can be understood that this third non-limiting example provides for a 2-D rectangular lattice occupying minimum volume when being shipped to the field, because it is optimized for partial assembly in the field, as follows:

All tubular parts may be made separately in the factory and assembled in the field as shown in FIG. 3h followed by inserting pins 460, which completes the 2-D rectangular lattice.

The above description captures the essence of the optimization of the 2-D rectangular lattice for economy (use of corrosion protected steel instead of aluminum and minimization of the number of welding operations) and the economy of use of material because of the elimination of the loss of strength in tubes 400a and 400b due to welding particularly at locations near connecting elements.

Furthermore, the so described 2-D rectangular lattice retains the use of thicker tubular connecting assembly 340 at the four extremities to bear pins 360 whose use has been previously described, however now the aluminum component of the tubular connecting assembly 340 lies outside tube 400a and 400b, thereby constraining tube 400a and 400b so that the pin does not deform tube 400a or 400b local to the pin under adverse loads, meaning the thickness of tube 400a and tube 400b can be thinner to economize on material use. This same constraining effect applies equally at locations with pin 460 as shown in FIG. 3h.

Tubes 420a and 420b though shown would not be necessary in all cases, as would be understood by one practiced in the art, however if both are present they would preferably be located on opposite sides of the 2-D rectangular lattice and may optionally be further secured by an additional fastener of any kind at intersecting location 470 of tubes 420 and 420c as shown in FIG. 3h.

Preferably, tube 420a would be twinned, one on each side of the 2-D rectangular lattice, eliminating tube 420c, because tubes 420a so described would typically exist in tension, thus economizing on the use of material within the assembled lattice.

2-D Triangular Lattice

Referring to FIG. 4a, the 2-D triangular lattice functions as a repeating unit of the building structural system.

The dimensions of the 2-D triangular lattice conform generally to the principal diagonal dimension of the repeating 2-D cell structure that governs the arrangement of the building structural system, assuming that the preferred arrangement where only one 2-D rectangular lattice of fixed dimension is used throughout the structure.

Referring to FIG. 4a, 2-D triangular lattice 480a communicates with the lower opposed corners of the corresponding 2-D rectangular lattices at 490a and 490b.

Preferably, from the apex 550 of the 2-D triangle lattice to the lower opposed corners of the corresponding 2-D rectangular lattices at 490a and at 490b are of equal distance.

Similarly, another 2-D triangular lattice 480b, alone or in combination with 2-D triangular lattice 480a as shown on FIG. 4a communicates with the lower opposed corners of the corresponding 2-D rectangular lattices at 490c and 490d.

Preferably, 2-D triangle lattice 480a and 480b share the same apex 550.

Preferably, for economy, the 2-D triangular lattices are used singly per so called “bay” of the repeating building unit 310 for the floor support and/or building unit 320 for the roof support of the building structure (now for simplicity of illustration shown in FIG. 4a as 510), in which case their orientation will be reversed back and forth as one proceeds from bay to bay, as would be understood by a person skilled in the art, to maximize the diagonalization of the resulting structure, which can now be described as a 3-D space frame that involves the use of composite panels to eliminate members that would otherwise be required in a space frame structure.

Preferably, apex 550 may serve as a place holder which will later on be connected to the centroid of the lower surface of a floor or roof composite panel located above the 2-D cell structure 510 by any means.

Preferably, apex 550 is coincident to the centroid of the lower surface of a floor or roof composite panel located above the 2-D cell structure 510.

Preferably, the 2-D cell structure 510 is a cubic structure.

Preferably, apex 550 is at the center of the top plane of the cubic 2-D cell structure 510.

Preferably, for strength, and particularly for imparting torsional resistance to the resulting 3-D space frame so described, both 2-D triangular lattices 480a and 480b are used conjointly in each so called “bay” of the repeating 2-D cell structure in the foundation.

Referring to FIG. 4b, the 2-D triangular lattice 480a/480b is a predominantly planar structure that consists of tubes and plate formed elements and other suitable features such as solid objects connected or welded together.

Preferably, the 2-D triangular lattice 480a/480b bears tubular connecting assembly 340, as previously described, at its two lower ends 490a and 490b to provide connection means to the rest of the 2-D cell structure 510.

It can be readily understood that the 2-D triangular lattice shown in FIG. 4b can be considered a subset of the 2-D rectangular lattice as previously described. Therefore, the 2-D triangular lattice may be made similarly to that of the 2-D rectangular lattice as previously described and illustrated in FIGS. 3a-3h.

Preferably, the apex 550 of the triangular 2-D triangular lattice 480a/480b is reinforced by a vertical member 560 to receive point loads which will be described later.

To accommodate the 2-D triangular lattice for transport by air pallets, therefore favoring transportation and logistics, the 2-D triangular lattices 480a and 480b may be further sub-divided into smaller units.

Referring to FIG. 4c, preferably, when both 2-D triangular lattices 480a and 480b are used in the same cell of the repeating 2-D cell structure, for example in the floor support which supports the floor composite panels and in the roof support which supports the roof composite panels, each of the 2-D triangular lattice 480a/480b may be broken down into two equal triangular sub-lattice 570a and 570b, where four such triangular sub-lattice are required to effect two full 2-D triangular lattice 480a and 480b, the maximum dimension of any of these four triangular sub-lattice is now less than the length of the 2-D rectangular lattice previously described, which was optimized to be within the dimensions of an air transport pallet.

Preferably, the 2-D triangular sub-lattice 570a and 570b can be made nearly as exact copies of each other, thus minimizing the number of different parts required to express the various configurations that are possible and advantageous.

Preferably, the 2-D triangular sub-lattice 570a and 570b may be connected by any fastening means so that they share apex 550 and a connection at their lower extremities.

Preferably, the 2-D triangular lattice 480a/480b bears tubular connecting assembly 340, as previously described, at its two lower ends 490a and 490b to provide connection means to the rest of the 2-D cell structure.

Preferably, connection means 550 and 560 are placed after the 2-D triangular lattices 570a and 570b are attached at 340 in order to facilitate assembly.

Preferably, the fastening means used at 550 and 560 is inserted vertically to facilitate alignment of the vertical fastening means without needing to adjust the length of the lower most extremity of 570a and 570b because the 2-D triangular lattices are being installed after the 2-D rectangular latticed used to define the repeating 2-D cell structure.

Referring to FIG. 4d, an illustrative and non-limiting example for a minimally functional 2-D triangular lattice can be assembled economically where sides of the triangle are flexible members 575a/575b held in tension, for example, by a wire rope, a woven trap, etc.

Preferably, the horizontal base of the 2-D triangular lattice is made from tubes as described previously for the 2-D rectangular lattice.

To accommodate shipping constraints, the horizontal base of the 2-D triangular lattice may be further divided, wherein the two sub-parts may be connected by connecting means.

Preferably, sub-tubular elements 580a and 580b bear tubular ends 590a and 590b towards the center of the 2-D triangular lattice as shown in FIG. 4d, where the tubular ends 590a and 590b are provided with sets of opposed holes to allow placement of a spigot 595 using pins 370. Spigot 595 allows for a degree of adjustment in the length of the base of the 2-D triangular lattice, which is useful for squaring up the bays constructed using 2-D rectangular lattices that are not adjustable in length.

Preferably, the tubular ends 590a and 590b as well as the spigot 595 are provided with a multiplicity of potential holes arranged in any pattern that is useful for being able to adjust the overall length of the 2-D triangular lattice.

Preferably, one of the patterns conforms to varying the overall horizontal length of the 2-D triangular lattice by simple rotation of the spigot until the next set of holes align, the rotation being in one direction for shortening, and the direction of rotation being counter to the first for lengthening.

This description does not preclude other mechanisms for adjusting the length of the 2-D triangular lattice, which may include screw threads of any kind.

1-D Pier

1-D piers, shown in FIG. 5a, which are predominantly linear elements, connect the 2-D rectangular lattices (which form the repeating 2-D cell structure) to the rest of the building structural system.

Preferably, 1-D piers also connect the 2-D triangular lattices which form the repeating 2-D cell structure.

Depending on where the 1-D piers are located within the building structural system, attachment means at the top and/or bottom of the 1-D piers may be provided as will be described.

The dimensions of the 1-D pier conform generally to the height of the 2-D rectangular lattice.

Referring to FIG. 5a, preferably, the 1-D pier 600 is provided with protrusions at connecting points 610a and 610b, said protrusions act as objects 380 in relation to the tubular connecting assembly 340 as shown in FIG. 3c. The 1-D pier 600 is connected to its adjacent 2-D rectangular lattices at connecting points 610a and 610b through the tubular connecting assemblies 340.

Preferably, the distance between the protrusion at connecting point 610a and the protrusion at connecting point 610b equals the distance between the two vertically aligned tubular connecting assemblies 340 shown in FIG. 3b (i.e., the height of 2-D rectangular lattice of 300a when said 2-D lattice of stands vertically) so to connect 1-D pier 600 with its adjacent 2-D rectangular lattice(s).

The 1-D pier 600 is connected to the upper and lower corners of the adjacent 2-D rectangular lattice(s) through the protrusions at connecting points 610a and 610b, each of connecting points 610a and 610b is equipped with a set of up to four protrusions spaced radially at 90 degrees relative to each other, the two sets of protrusions are aligned vertically respectively.

Preferably, 1-D pier 600 is also provided with protrusions at connecting point 610c, said protrusions act as objects 380 in relation to the tubular connecting assembly 340 in FIGS. 4b-4d and 4c in a fashion that as illustrated in FIG. 3c. The 1-D pier is connected to its adjacent 2-D triangular lattice(s) at connecting point 610c through the tubular connecting assemblies 340.

Preferably, the 1-D pier 600 is connected to the lower extremities of the adjacent 2-D triangular lattice(s) through the protrusions at connecting point 610c, connecting point 610c is equipped with a set of up to four protrusions spaced radially at 90 degrees relative to each other but rotated 45 degrees with respect to the protrusions at 610a and 610b. Connecting point 610c may be positioned vertically above, below or at the same elevation as 610b, by means which will be described later.

Preferably, connecting points 610b and 610c are located at substantially the same elevation to impart the greatest strength to the resulting structure.

The 1-D pier 600 is a repeating element in both the floor support which supports the floor composite panels and in the roof support which supports the roof composite panels

Although it may be configured variably by location, preferably, the body of the 1-D pier 600 is made identical in all cases, thus economizing on the number of parts required.

Preferably, the body of the 1-D pier 600 is tubular. Preferably, it is made from lightweight aluminum or aluminum alloy.

Another purpose of the 1-D pier 600, when located in the floor support which supports the floor composite panels, as shown in FIG. 3a, is to collect and transfer loads from the building structure to the ground.

Preferably, a lower assembly at the bottom of 1-D pier 600 comprises a steel insert 620 at the bottom which carries a threaded void to receive a steel screw 630 in order to adjust the height of the 1-D pier relative to the ground elevation.

Preferably, the adjustable screw 630 bears against a plate 640 by any means, in order to spread the load from above to the ground.

Preferably, plate 640, on its bottom, bears at least one or more pin 650 of any kind, in order to restrain the movement of the 1-D pier relative to the ground, thus securing the structure laterally against the influence of wind and seismic activity.

Preferably, plate 640 is attached firmly by any means to the screw 630.

Preferably, plate 640 may further comprise a plate protrusion 660 which can be impacted by a heavy object to rotate the plate 640 and therefore the screw 630 in order to carry the level of the 1-D pier relative to the ground elevation. This feature favors the use of one single pin 650 centered on the screw 630 such that the plate is free to rotate when feature 660 is used. Furthermore this feature can be used even after the building is assembled, and/or after the ground moves due to the influence of wind and seismic activity.

Preferably, an upper assembly, located at the top of 1-D pier 600, bears a steel insert 670 at the top which carries a threaded void to receive a screw 680 in order to adjust the height of structural elements located above the 1-D pier.

Preferably, when the 1-D piers are located at the perimeter of the building, screw 680 may further bear against a plate 690 by any means that allow the plate 690 to rotate relative to screw 680, in order that plate 690 can remain at a preferred orientation relative to the structural elements located above the 1-D pier.

Preferably, the plate 690 bears at least one hole(s) 698 through which strap(s) may be looped to further secure 1-D piers.

Preferably, when the 1-D piers are located at the perimeter of the building (but excluding at the four corners of the building), a plate 690 may further bear a protrusion 695 of any kind (a bulge stopper) on its top, in order to restrain the movement of the structural elements located above the 1-D pier (for example, 1-D column) relative to the 1-D pier, thus securing said structure elements to the 1-D pier laterally against the influence of wind and seismic activity.

The interior 1-D piers can be similarly modified to have similar type of receiving structure for the 1-D columns if interior building columns are desired, for example, when a second story is added.

Protrusions at connecting points 610a, 610b and/or 610c, which act as objects 380 in relation to tubular connecting assemblies 340 are connected to 1-D piers through various connecting means as described herein below.

Preferably, said protrusions may be connected to 1-D piers using bolting means.

FIG. 5b is a top view of an illustrative and non-limiting example of a bolted protrusion on the 1-D pier, interacting with the circular tube 700 of the 1-D pier shown in cross-section.

Preferably, bolted protrusion 710 is made from steel alloy or aluminum alloy in cast form, which is economical for the overall shape and finish machining required.

Preferably, the overall shape of the outer extremity of bolted protrusion 710 is generally circular in order to be inserted into receiving tubular element 350 of the tubular connecting assembly 340 shown in FIG. 3b (not shown in FIGS. 5a/5b) on the corresponding 2-D rectangular or 2-D triangular lattice(s).

Preferably, as shown in FIG. 5c, a side view of said bolted protrusion on the 1-D pier, the overall shape of the inner extremity of bolted protrusion 710, as it approaches the circular tube 700 of the 1-D pier, is elongated vertically, or flared outwardly along circular tube 700 of the 1-D pier. The flared-out feature assists to spread the load being transferred to the 1-D pier, while providing a capacity to transfer moments from the corresponding 2-D rectangular or triangular lattice(s), through the protrusion 710, to the 1-D pier.

Preferably, the bolt type fastener 720 is made from a high strength, heat treated, and fracture resistant alloy. Preferably, it is able to endure arctic temperatures below minus 40° C.

Referring to FIGS. 5b and 5c, preferably, the bolt type fastener 720 is removable, and provided with a load indicating washer 730 to indicate the correct torque has been reached on installation.

Preferably, bolted protrusion 710 is bolted to the circular tube 700 of the 1-D pier by the removable bolt type fastener 720 received by an insert 740 which is snug fitted inside the circular tube 700 of the 1-D pier and acts as receiving element of the inserting end 735 of bolt type fastener 720.

Preferably, insert 740 is made of a non-galling, heat treated steel alloy, compatible with the bolt type fastener 720.

Preferably, the outer extremity of bolted protrusion 710 bears a set of opposed radial holes 750 oriented in any manner so that the centerline 760 joining the two holes transects the centerline of the end of the protrusion which is circular in cross section.

Preferably, a pin centered on 760 is used to secure bolted protrusion to the corresponding 2-D rectangular or triangular lattice(s).

Referring again to FIG. 5b, preferably, the set of radial holes 750 align with the set of holes 360 (360a and 360b) as shown in FIG. 3c so that pin 370 may be used to transact both holes 750 and holes 360 to secure bolted protrusion 710 to the corresponding 2-D rectangular or triangular lattice(s).

Preferably, the outer extremity of bolted protrusion 710 bears a recess 770 to economize the materials used and facilitate the function of the pin.

Now it can be understood the 1-D pier shown in FIG. 5b can have up to twelve such bolted protrusions over the height of the pier, preferably at not more than three separate elevations, with up to four of said bolted protrusions located near the top of the 1-D pier at connecting point 610a as previously described, and up to eight said bolted protrusions located near the bottom of the 1-D pier at connecting point 610b and 610c as previously described.

Preferably, the up to eight bolted protrusions located near the bottom of the 1-D pier at connecting point 610b and 610c are arranged on two parallel and closely spaced horizontal planes, where the upper four of this lower set of eight bolted protrusions are rotated 45 degrees with respect to the lowest four of this set of eight bolted protrusions, in order for the upper four of this lower set of eight bolted protrusions to be oriented to connect to the 2-D triangular lattice(s), as the case may be.

Preferably, the up to eight bolted protrusions located near the bottom of the 1-D pier at connecting point 610b and 610c are arranged on the same plane.

Preferably, for space economy, as shown in FIG. 5d, a top view of an illustrative and non-limiting example of a bolted protrusion on the 1-D pier, the overall shape of the outer extremity of bolted protrusion 710, as it approaches the circular tube 700 of the 1-D pier, is narrowed horizontally, or flared inwardly along the radial plane cross-sects the circular tube 700 of the 1-D pier.

An alternative embodiment is to substitute bolted protrusions 710 at 45 degree with an eye-bolt.

FIG. 5e is a non-limiting example of such an embodiment. Eye-bolt 780 is inserted through the circular tube 700 of the 1-D pier to bear an insert 740 in a similar fashion to the bolted protrusions described above.

Preferably, the eye-bolt can be finally positioned so the flat shaped head receives the pin vertically, thus reducing the chance of interference of the pin and adjacent protrusions or 2-D rectangular lattice elements, while it is being installed.

It can now be understood, that the embodiment described in FIG. 5d, is a combination of elements previously described made possible by the use of an eye-bolt, so as to enable the up to eight protrusions that may be necessary at the lower end of the 1-D pier to be positioned very close to or exactly onto the same horizontal plane, thus strengthening the overall structure by close alignment of the forces being transferred.

Furthermore, the use of adjustable eye-bolts at each end of the lower horizontal element of the 2-D triangular lattice, when the lower horizontal element is used alone, can be reduced to a single tubular member, with or without the use of a pinned spigot breaking the member into two sections to match air transport shipping constraints, because the resulting lower horizontal element of the 2-D triangular lattice need not be adjustable in length to be installed.

FIG. 5f (top view) and FIG. 5g (side view) is a further illustrative and non-limiting example, where casting/forging (shown at left) or welding (shown at right) forging methods are used to create the protrusions on the 1-D pier.

Preferably, protrusions 790 are made substantially by casting/forging or welding, in order to economize considering the overall shape and finish machining required.

Referring to FIG. 5f, preferably, the shape of the protrusion 790 bears vertical sides that are substantially flat and tend to converge as the extension approaches the circular tube 700 of the 1-D pier radially, thus permitting the use of a substantially linear welds 795a and 795b to affect the connection of the protrusion 790 to the 1-D pier.

Preferably, the portion of the protrusion 790 that is in close contact with the circular tube 700 of the 1-D pier is wide enough to achieve reasonable separation of the two welds 795a and 795b used to connect the protrusion 790 to the circular tube 700 of the 1-D pier to minimize the loss of strength in the 1-D pier material caused by the overlapping of welding heat affected zones.

Preferably, the shape of the protrusion 790 bears substantially flat top and bottom surfaces so inclined as to converge as the protrusion 790 proceeds away from the circular tube 700 of the 1-D pier radially, thus creating welds at the pier that are longer than the corresponding 2-D lattice tube diameter, to impart substantial strength to the connection—particularly for resisting moments about the horizontal axis at the joint.

Preferably, protrusion 790 bears the shape of a tongue that is close fitting to all points of the inside profile of the adjoining 2-D rectangular or triangular lattice, which has previously been described.

Preferably, the material used for protrusion 790 is a lightweight metal, such as aluminum or aluminum alloy that is especially resistant to cyclic stresses and resulting cracking without the use of post weld heat treatment in order to economize on manufacturing operations.

Preferably, the material used for protrusion 790 is a lightweight metal, such as aluminum or aluminum alloy that welds readily to the pier.

Preferably, the material used for protrusion 790 is the same or similar in composition to Almag™ 35 which is differentiated by its superior ductility without post weld heat treatment.

Preferably, the convergence of the faces of protrusion 790 when viewed from above, when approaching the pier, is useful for preventing interference with other structures that may be present, for example the eye-bolts as previously described.

Preferably, the extremity of protrusion 790 is configured to receive a pin 798 that is inserted horizontally, so as to relieve stresses induced within the protrusion local to the hole that would be caused if the holes were aligned to receive a pin vertically.

Preferably, the convergence of the faces of protrusion 790 when viewed from above, when approaching the pier, is useful for improving the flow of material 799 between the 1-D pier 1 and protrusion 790, in either direction, during casting/forging processes, with economies involved with mass production in comparison to welding, produces a joint between the 1-D pier and protrusion 790 of superior strength as compared to a joint made by welding.

A person skilled in the art would understand that protrusions at connecting points 610a, 610b and 610c may be a combination of the bolted protrusions, eye-bolted protrusions, and forge welded protrusions as described above.

Furthermore, 1-D piers may be differentiated by the number of extension they bear, each according to the location in the foundation or superstructure, however this does not preclude the standardization of 1-D piers such that they arrive in the field with the extensions applied, which in some cases may not be used.

1-D Transom

Referring to FIG. 6a, a 1-D transom (structural beam) 800 is a predominantly linear element the purpose of which is to support composite panel 10 laid horizontally above.

As described previously, 2-D rectangular lattice 300a (300b, 300c, or 300d) each bears receiving means 345 at midpoint of the top of said 2-D rectangular lattice when said lattice is placed vertically.

Said receiving means are to receive a transom hub connector which is used to connect the 1-D transoms to the 2-D rectangular lattice.

As shown in FIG. 6a, four 1-D transoms 800 are arranged per bay of the building unit 310 for the floor support and/or building unit 320 for the roof support of the building structure, each being rotated 45 degrees to the orientation of the 2-D rectangular lattices used to define the building unit 310 for the floor support and/or building unit 320 for the roof support of the building structure.

Preferably, said four transoms 800 are connected at receiving means 345 to form a rectangle. Preferably, the rectangle is a square.

Preferably, the square of transoms composed of four transoms 800 is placed on building unit 310 for the floor support and/or building unit 320 for the roof support of the building structure.

Horizontal composite panel 10 is placed on the square of transoms such that the perimeter of the horizontal composite panel lies on the centerline of the four 1-D transoms 800.

Preferably, 1-D transom is made of metal that is durable when being transported, stored out in the open or when subjected to flooding. Such durability is an important part of the design which does not favour the use of wood products.

Referring to FIG. 6b, which provides an end view of 1-D transom 800, preferably, 1-D transom 800 is built with two pieces of material sheets 810a and 810b.

Material sheets 810a and 810b are assembled together with a tongue 830 inserted therein between. Preferably, material sheets 810a, 810b and tongue 830 are all connected by connecting means 840 to form a transom with a general shape resembling an “I” beam.

Preferably, 810a and 810b are made with thin walled lightweight material such as corrosion protected steel, aluminum alloy or any other suitable material.

Preferably, 810a and 810b are made with materials that can be roll formed.

Preferably, the 1-D transom 800 is made from corrosion protected steel sheet 810a and 810b such as Galvalume™ which is known to resist corrosion even at the unprotected edges.

To minimize lateral movement between horizontal composite panel 10 and the square of transoms composed of four transom 800 which supports horizontal composite panel 10, restraining means are employed.

Referring to FIG. 6b, preferably, 1-D transom 800 features a pocket 820 near the top center to restrain flanges 140a and 140b that are attached to the underside of adjacent horizontal composite panels 10 as previously described.

Preferably, pocket 820 may generally resemble a V-shape or U shape.

Preferably, flanges 140a and 140b attached to the underside of composite panel 10 may be inserted into pocket 820 to allow pocket 820 to restrain the flanges 140a and 140b from moving out of pocket 820 and the composite panel 10 from lateral motion versus the 1-D transom. Such restraining means may eliminate the need of using field fasteners between the panels 10 and the 1-D transom 800.

Preferably, the seam between adjoining horizontal panels feature flanges are fully contained in the center top pocket 820 presented by the 1-D transom.

Preferably, the amount of play between the so inserted flanges and the pocket of the transom is such as to provide a means for absorbing horizontal panel dimensional tolerances without compromising the lateral restraining feature of the transoms to the flanges and thus the horizontal panels, especially during high wind and seismic events.

Referring to FIG. 6c, the 1-D transom 800 (side view) is terminated at each end by a tongue 830 joined with 810a and 810b (not shown) by connecting means 840.

Preferably, tongue 830 flares outwards with an angle 850. Preferably, the flared angle 850 is ≥90.

Preferably, tongue 830 is built up from laminated heat-treated steel layers to improve the strength of the tongue where it is angled.

Preferably, angle 850 contributes to an ease of fit-up of the ends of the 1-D transom to the corresponding transom hub connector 860, as described later.

A transom hub connector is used to connect 1-D transom to the 2-D rectangular lattice.

Preferably, a transom hub connector is connected to receiving means 345 located at midpoint of the top of a 2-D rectangular lattice when said lattice is placed vertically.

Preferably, tongue 830 of 1-D transom may be inserted into the vertical groove 880 of a fluted solid object 870. The flute solid object is part of transom hub connector 860 and centers towards the connection with the tongue 830 of the 1-D transom.

Preferably, fluted solid object 870 is cupped by washers 890a and 890b at the top and bottom end of fluted solid object 870 respectively.

Preferably, the cupped washers 890a and 890b are to bear the tongue 830 without damaging the tongue even when the transom hub connector is assembled and taken apart and re-assembled many times.

Preferably, the cupped washers 890a and 890b are made of heat treated alloy steel.

Preferably, the solid flute object 870 is held by a rod 895 by fastening means to the rest of the transom hub connector.

Referring to FIG. 6d, which is a top end view of the fluted solid object, preferably, fluted solid object 870 has up to four vertical grooves 880 to receive up to four 1-D transoms, each 1-D transom has an end tongue 830 which may be inserted into the vertical grooves as previously described.

Preferably, each vertical groove 880 is at 90 degree to the adjacent vertical groove, with the rod 895 in the center of the fluted solid object 870 when viewed from above.

Rod 895 may have various embodiments depending on the location of where the transom hub connector is located.

When the transom hub connector is connected a 2-D rectangular lattice where the 2-D rectangular lattice in located in the interior of the building structure, preferably, the rod 895 bears a slot 896 at the top of the rod, said slot with a flat lower face and an angled upper face as shown in FIG. 6e.

Preferably, tightening means such as a threaded fastener or a wedge pin may be used to tighten the upper cupped washer 890a against the fluted solid object 870.

Preferably, slot 896 is filled by horizontal insertion of a wedge pin 897 with a serrated upper edge as shown in FIG. 6e, which contributes to the retention of the wedge pin 897 when the wedge pin 897 is driven into the slot 896 by impact.

Referring again to FIGS. 6c, preferably the distance between upper and lower extremities of the flared-out tongue 830 is greater than the vertical height of the fluted solid object 870.

Preferably, such dimensioning of the tongue 830 and fluted solid object 870 contribute to the cupped washers 890a and 890b being squeezed against the tongue 830 when the cupped washers 890a and 890b are tightened, rather than squeezed against the solid object 870 in order to secure the 1-D transom to the transom hub connector by the insertion of the wedge pin 897.

When the transom hub connector is connected to a 2-D rectangular lattice where the 2-D rectangular lattice in located along the perimeter of the building structure, preferably, the rod 895 with slot 896 and wedge pin 897 therein bears a threaded end higher than slot 896 as shown in FIG. 6f.

Preferably, plate 690 (as described previously in FIG. 5a) can be inserted over the threaded end of rod 895 secured by screwing on protrusion 695 of any kind (a bulge stopper), in order to restrain the movement of the structural elements (for example, 1-D column) located above the transom hub connector relative to the transom hub connector, thus securing the structural elements to the transom hub connector laterally against the influence of wind and seismic activity.

Preferably, plate 690 bears at least one hole(s) 698 through which strap(s) may be looped to further secure the structural elements located above the transom hub connector (for example, wall composite panel), which will be fully described herein under.

Referring to FIGS. 6g and 6h, preferably, transom hub connector is connected to the 2-D rectangular lattice through receiving means 345.

Preferably receiving means 345 is profiled to connect with tubes 400a and 410c of the 2-D rectangular lattice using welds 899 as shown in FIG. 6g.

Preferably, receiving means 345 is profiled at the top to receive the lower cupped washer 890b of the transom hub connector and bears a central void threaded to receive the rod 895 from above, thus completing the connection of the 1-D transom to the repeating building unit 310 for the floor support and/or building unit 320 for the roof support of the building structure.

Referring to FIG. 6h, shown is a perspective view of the transom hub connector which comprised a fluted object 870, cupped washers 890a and 890b and rod 895. The fluted object 870 has four vertical grooves 880 which are 90 degrees to each other. Tongue 830 of the 1-D transom, which is joined to the rest of the 1-D-transom by connecting means 840, is inserted into vertical groove 880 therefore connecting with 1-D transom and 2-D rectangular lattice by receiving means 345 which is profiled to connect with tubes 400a and 410c of the 2-D rectangular lattice.

As would be understood by a person skilled in the art, triangular horizontal composite panels will be required along the perimeter of the structure, in order to complete the floor and roof. Such triangular horizontal composite panels can still be packed four together on top of a square panel, thus facilitating transport by air using pallets.

1-D Column

Referring to FIG. 7a, a 1-D column 900 is a predominantly linear element whose function is to bear the roof support which supports the roof composite panels onto the floor support which supports the floor composite panels.

Such bearing is facilitated by the use of common dimensions for the repeating 2-D cell structure within both the floor support and the roof support thereby creating multiple alignment opportunities.

Preferably, the common dimensions for the repeating 2-D cell structure in the both the floor support and the roof support are rectangular, more preferably square, thereby allowing the use of only one size of 2-D rectangular lattice throughout the entire building structural system.

The use of common dimensions for the repeating 2-D cell structure in both the floor support and the roof support allows for the placement of columns arranged vertically in order to connect piers in the roof support and their corresponding in alignment piers in the floor support.

Preferably, the roof support is designed to provide an open plan interior without the use of interior columns. However this does not preclude the use of interior columns, as for example when handling unusual roof loads and or a second story addition either at the time the building is first built or later during the life cycle of the building.

Preferably, the 1-D columns are used only along the perimeter of the building as shown in FIG. 7a, except for the locations at the corners of the building where a 1-D column is not required. The corner of the building is shown as the origin from which direction A is along the wall on the width of the building (short edge) and direction B is along the wall on the length of the building (long edge).

Preferably, the 1-D columns 900 are made in one or more parts for ease of transportation and to comply with the dimensions of air transportation pallet. When a column is made in more than one part, the parts are splined together with the use of moment resisting spigots 595 and pins 370.

Preferably, the 1-D columns are made of a lightweight metal, such as aluminum or aluminum alloy.

Preferably, the 1-D columns are round in their outer perimeters and are made to fit snugly into corresponding voids created in the vertical mating faces of edge profile 85 of the adjacent wall composite panel 10, where the edge profile 85 coincides with the outer perimeter of columns 900.

This does not preclude the use of double columns of any shape that are separated by a multitude of solid objects firmly spacing the two columns across the face of the vertical mating edges of adjacent wall panels, thereby creating a ledger or truss which is also a column with a doubling of the spline or sealing effect as would be understood by one practiced in the art.

Preferably, the orientation of said ledger contributes to a greater amount of strength in the direction oblique to the wall panel face as compared to the direction along the wall panel face, which a person skilled in the art would recognize as providing a truss effect to the column function in a manner that is optimum for restraining the walls of the building.

Referring to FIG. 7b, preferably, the abutting vertical faces of adjacent wall composite panels 10 are centered on the 1-D columns 900 and bear an edge profile 85 as previously described to fit snugly against the 1-D column, allowing the 1-D column to serve as both a spline and a seal in the space between adjacent wall composite panels 10.

Preferably, for economy and ease of construction, the edge profile 85 is located in the Polystyrene (PS) layer 61 of layer (b) 30 of the composite panel as previously described.

Preferably, this envelopment of the 1-D column at the vertical mating faces of adjacent wall composite panels is strengthened by the action of the flanges which have been previously described which are connected to the outer surface(s) of the wall composite panels, with the columns being braced in the plane of the wall composite panels by the presence of the wall composite panels, as opposed to by the addition of traditional cross bracing to the metal part of the building structural system.

Referring again to FIG. 7a, preferably, the bottom of 1-D column 900 (900AA and 900BB) bears upon a plate 690 attached to the underlying 1-D pier 600 in the floor support which supports the floor composite panels by means as previously described. Preferably, plate 690 bears at least one hole 698 for terminating straps which will be described later. Plate 690 may also be attached by any mechanical means to the wall panel bottom corners in communication with plate 690 as would be understood to a person skilled in the art.

Preferably, the 1-D column is restrained laterally by a protrusion 695 that proceeds vertically upward from the plate 690 and fits snugly into the base of the 1-D column 900 (900AA and 900BB) in order to restrain the 1-D column laterally as a minimum. Protrusion 695 may also be attached by any mechanical means to the base of the 1-D column in order to restrain the 1-D column vertically as would be understood by a person skilled in the art.

Preferably, the top of the 1-D columns may be finished to receive one of two connections.

Referring to FIG. 7a, there is no need for 2-D rectangular lattice(s) along the perimeter of the building at the top of the 1-D columns because the composite wall panels themselves are used for bracing the 1-D columns in the plane of the walls.

The first connection is reserved for longer 1-D columns 900BB whose purpose is to present a transom hub connector at the correct height within the wall system. These longer columns replace the function of the transom hub connector on top at the middle of a 2-D rectangular lattice that would otherwise transect the edges of the repeating 2-D cell structure along the perimeter of the building, which as explained—is not required.

Preferably, said longer 1-D columns 900BB bear a treaded void to receive a transom hub connector which has been previously explained.

The second connection is reserved for shorter 1-D columns 900AA (located on top of 1-D piers) that transect the edges of the repeating 2-D cell structure along the perimeter of the building.

Referring again to FIG. 7a, preferably, the shorter 1-D column 900AA is attached to the 1-D pier above by a moment resisting spigot 595 that is pinned at both ends by pins 370.

2-D Rigid Frame Assembly

Referring to FIG. 7c, a 2-D rigid frame assembly 950 can be constructed using the parts previously described.

Preferably, such 2-D rigid frame assembly 950 is used in the principal direction B (long edge) which traverses the width A (short edge) of the building wherein B>A.

Preferably, the 2-D rigid frame assembly 950 is a 2-D planar assembly comprises columns 900a and 900b, piers 600 (600a, 600b, 600c), and one or more 2-D planar lattices which together bear on plates 690 on top of the 1-D piers when the 1-D pier is located in the floor support of the building as previously described (see FIG. 5a).

Preferably, columns 900a and 900b may be of equal or different length to suit shipping needs. The total length of columns 900a plus 900b on one side of the 2-D rigid frame assembly equals the total length of columns 900a plus 900b on opposite side of the 2-D rigid frame assembly.

Preferably, the 2-D rigid frame assembly 950 resists lateral loads using rigid connections which are moment-resisting thereby contributing to the strength of the building.

For ease of assembly, for example, without the use of special tools such as ladders and/or cranes, a 2-D rigid frame assembly may be assembled on a horizontal surface at or near ground level.

Preferably, 2-D rigid frame assembly is assembled on the floor after the floor support and floor composite panels have been assembled.

Preferably, pins 370 are used for the 2-D rigid frame assembly connections to connect spigots 595 between columns 900a and 900b, and spigot 595 between the top of 1-D column and bottom of 1-D pier when the 1-D pier is located in the roof support (as shown in FIG. 7a) while the 2-D rigid frame assembly is lying flat.

Once the 2-D rigid frame assembly is assembled, the top of said 2-D rigid frame assembly may be tilted or rotated upwards such that the bottom of the 1-D columns are placed onto the protrusions 695a and 695b (bulge stoppers) which are on top of plates 690.

Preferably, the diameter or dimension of protrusions 695 (695a, 695b) are such that their shear strength would be adequate for resisting the lateral movement of the columns once the 1-D columns are inserted over protrusions 695 (695a, 695b).

To facilitate the tilting and placement of the 1-D columns onto protrusions 695 (695a, 695b) without having to lift off entirely the 2-D rigid frame assembly, protrusions 695 (695a, 695b) with a profile rounded on their top would be preferred.

Preferably, the 2-D rigid frame assembly 950 is restrained from vertical uplift using straps which will be described later, though this does not preclude the use of additional shear pins local to plate 695 as would be understood by a person skilled in the art.

Preferably, the 2-D rigid frame assembly 950 so assembled and tilted vertically are held upright by the close fit up of adjacent wall composite panels, which are fastened around the 1-D columns by the action of flanges as previously described. This can be repeated along the direction of the building length “B” (longer edge) resulting in a rapid assembly sequence that does not require the use of traditional fasteners, tools or a crane as all parts can be positioned by hand even in adverse weather conditions.

The above sequence for placement of individual 2-D rigid frame assembly 950 along the principal direction B (longer edge) of the building is compatible with sequential placement overhead of individual parts such as 1-D piers and 2-D rectangular lattices, which are easy to lift into place individually. Repeating such sequence assists completing more 2-D rigid frame assemblies 950 oriented along the principal dimension B of the building, resulting in completion of the 2-D repeating cell structure overhead, such that 2-D rigid frame assemblies 950 are along the two principal directions A and B of the building, thereby contributing to the strength of the building due to the bi-directional disposition of 2-D rigid frame assemblies and the bracing of same using wall composite panels around the perimeter of the building.

Referring to FIG. 8a, the repeating building unit 310 for the floor support and/or building unit 320 for the roof support of the building structure (also shown in FIG. 4a as 2-D cell structure 510) is further strengthened by the addition of one or two 2-D triangular lattices 480a and 480b as shown.

Preferably, apex 550 is coincident to the centroid of the lower surface of a floor or roof composite panel located above the building unit 310 for the floor support and/or building unit 320 (also shown in FIG. 4a as 2-D cell structure 510).

Preferably, the apexes also communicate with the horizontal composite panel 10 at or near the centroid of the panel. Preferably, said means of communication is a field applied fastening means minimizing the conduction of heat through the horizontal composite panel even though the field applied fastening means may pierce the horizontal composite panel completely.

Preferably, said fastening means is a loop of 960. Preferably, loop 960 is plastic that may be reinforced with fiber elements. Preferably, loop 960 is inserted and tightened by means typical in the shipping trade, for example, shipping bands or straps with buckles or clips used to secure the two ends thus forming a loop.

Preferably, the connection of 2-D triangular lattices 480a and 480b to the composite panel 10 at or near the centroid of composite panel 10 add strength and stability both horizontally and vertically which make is possible to minimize the required thickness of the composite panels, therefore reducing costs.

For economy, 2-D triangular lattice assemblies may not be applied to each and every 2-D repeating cells in the building structural system.

The use of the 2-D triangular lattices and connecting them to the above horizontal composite panels provides torsional stability to the overall structure.

Preferably, for economy, 2-D triangular lattice assemblies 480a and/or 480b are used in the floor support of the floor composite panels and are subsequently connected to the horizontal composite panel 10 at or near the centroid. The use of one or more 2-D triangular lattices and their respective interconnection means with composite panel provides torsional stability in the floor support system.

### Shear Pins With Retention Means

Preferably, pins 370 may be in the shape of a specialized reusable locking shear pin with retention means.

Such re-usable shear pins with retention means maybe used to secure the various parts of the building structural system.

For example, such shear pins may be used in the tubular connecting assembly 340 (as shown in FIG. 3c) to connect the 2-D rectangular lattice (300) to the adjacent 1-D piers (600), used to connect the sub-tubular elements 580a and 580b to construct a 2-D triangular lattice as shown in FIG. 4d, or used in the 2-D rigid frame assembly to connect spigots 595 between 1-D columns 900a and 900b, and spigot 595 between the top of 1-D column and bottom of 1-D pier when the 1-D pier is located in the roof support (as shown in FIG. 7c).

Preferably, said re-usable shear pins with retention means are shaped in a “pigtail” configuration.

Preferably, the retention means engages a sprung and locking mechanism. Such retention means further strengthens and secures a connection assembly where the shear pins with said retention means are used in any orientation.

Preferably, said shear pin with retention means is made from alloy steel that has been heat treated for strength and ductility.

Preferably, said shear pin with retention means is made from a cylindrical element of constant diameter that is cold formed, then heat treated.

FIGS. 9a and 9b are perspective views of said shear pin with retention means 970 being inserted through holes 360 (360a and 360b) and clamped around a tubular element 980.

FIG. 9c is an end view of said shear pin with retention means 970 being inserted through holes 360 (360a and 360b) and clamped around a tubular element 980.

Referring to FIGS. 9a and 9b, preferably, a shear pin with retention means 970 comprises a linear element 971 (linear pin portion), a vertical element 973, and a circular element 975 with a tail end 995 which is the last point of contact between shear pin 970 and the outer surface of tubular element of 980.

Preferably, linear element 971 (linear pin portion) is at 90 degree angle and in the same plane with the vertical element 973. Preferably, the length of linear element 971 (linear pin portion) is less than the length of vertical element 973. Vertical element 973 is at 90 degree to circular element 975, wherein circular element travels around the circumference of tubular element 980.

Tubular element 980 may be the tubular element 350 of the tubular connecting assembly 340 (as shown in FIG. 3c) to connect the 2-D rectangular lattice to the adjacent 1-D piers, or sub-tubular elements 580a and 580b to construct a 2-D triangular lattice as shown in FIG. 4d, or 1-D columns 900a and 900b (as shown in FIG. 7c).

Preferably, shear pin with retention means 970 is positioned where its vertical element 973 is parallel with the length of the tubular element 980 when the linear element 971 (linear pin portion) is inserted horizontally through holes 360 (360a and 360b) on tubular element 980 and optionally through an object 990 (for example, object 990 may be object 380 as previously shown in FIG. 3c) as shown in FIG. 9a, followed by rotation of the circular element 975 into a final position where the tail end 995 is the last point of contact between shear pin 970 and the outer surface of tubular element of 980.

Referring to FIGS. 9b and 9c, preferably, the rotation of circular element 975 is akin to a sprung action with a rotation angle 996, wherein angle 996 is defined as between the plane from hole 360b to about midpoint of 997 of linear element 971 to the plane between tail end 995 and midpoint 997. Said sprung action is responsible for holding the shear pin 970 in place through motions of the transected components during assembly or motions such as vibrations caused by wind and or seismic influences.

Preferably, angle 996 is greater than 180 degrees. More preferably, angle 996 is about 220 degrees.

Preferably, shear pin with retention means 970 may bear an additional outward turned feature 998 (shown in FIG. 9c) at the tail end 995 which may be curving away and not in touch with tubular element 980. This outward turned feature 998 is useful to prevent damage to the tubular element during insertion and can also be used to fit a pry-bar for ease of disengagement of the shear pin during removal.

It can now be understood that such a shear pin can be economically manufactured from wire and by the described insertion, rotation and locking actions provides a secure and re-usable connection means that can be used in any orientation and that does not require special tools or training to be installed or removed.

### Straps

Vertical Straps (Suspender Straps)

FIGS. 10a, 10b and 10c are illustrations of straps used to support and retain the building structure.

Referring to FIG. 10a and 10c, preferably, the building structural components are retained to the floor support using flexible straps 1000 of any kind that are secured to the floor support at one perimeter of the building, travel up and over the building and are secured to the floor support at the opposite perimeter of the building.

Preferably, straps 1000 proceed outboard of the structural component of the wall composite panels 10 (l0a and 10b) which envelop the building 1-D columns as previously described.

Preferably, straps 1000 proceed on top of the structural component of the horizontal composite panels 10 (10d) used for the roof which bear upon the 2-D rigid frame assembly 950 which has been previously described.

Preferably, the means of securing to the floor support is a loop through a hole 698 in the plates 690 (690a and 690b) which are in contact with the building perimeter 1-D piers in the floor support, as previously described.

Preferably, said vertical straps are made with material that is flexible and safe to handle in the field, being made with fibers that may be woven for strength and coated with plastic for durability.

Preferably, said straps can be secured by traversing the building and coming back to the origin to form a loop, whose ends can be attached using a simple rotating hand tool and wire buckle as would be understood by a person skilled in the art.

Preferably, said binding is protected from vandalism and the elements by placement between the exterior materials 250, for example cladding (80) and the underlying composite panels, using means that will be described later.

Preferably, vertical straps that travel vertically up and over the building to the other side (suspender straps) are located near the vertical seams between adjacent wall composite panels.

Preferably, suspender straps 1000 are located on either or both sides of the wall composite panel seam, outboard of the wall composite panel flanges 140a/140b. This location being optimal for the straps to resist uplift of the wall composite panel edges, a motion called racking, as would be the tendency when wind forces are being transferred through the building.

The racking resistance the suspender straps 1000 provide is in addition to the shear resistance provided by the flanges at the vertical seams of adjacent wall composite panels, as has been previously described.

Preferably, the plate 690 used to support the 2-D rigid frame assembly 950 is large enough to bear the lower corners of adjacent wall composite panels, as well as the securing means for one or more suspender straps 1000.

Horizontal Straps (Belt Straps)

Referring to FIGS. 10b and 10c, in addition to the suspender straps 1000 that travel vertically up and over the building to the other side, preferably, there are horizontal straps 1100 (belt strap) that travel horizontally around the building perimeter.

Preferably, at least two belt straps 1100 (1100a, 1100b) are used to encircle the horizontal composite panels that form the roof and the floor.

Preferably, the belt straps 1100 are centered vertically on their respective horizontal composite panels.

Referring to FIG. 10b, preferably, where a horizontal floor composite panel 10c is in contact with a wall composite panel 10a/10b at the bottom perimeter of the building, wall composite panel 10a/10b has a cutout portion so that the floor composite panel 10c is in set to the wall composite panel 10a/10b such that the inner portion 11b of the wall composite panel 10a/10b terminates and rests on the upper surface of the adjacent floor composite panel 10c.

Preferably, where a horizontal roof composite panel 10d is in contact with a wall composite panel 10a/10b at the upper perimeter of the building, wall composite panel 10a/10b has a cutout portion so that the roof composite panel 10d is in set to the wall composite panel 10a/10b such that lower surface of the adjacent roof composite panel 10d terminates and rests on the inner portion 11a of the wall composite panel 10a/10b.

Preferably, the combined action of the suspender straps 1000 the belt straps 1100 generally drives the wall composite panels into the horizontal composite panels located in the roof and floor.

Referring to FIG. 10c, preferably, the panels 10bb located at the corners (corner panels) of the building are made in one piece in L shape, i.e. monolithic, in order to bear the action of belt straps 1100 (1100a and 1100b) applied to the perimeter building, at one or more locations, but at least at the bottom and the top of the walls, in order to drive the corners into the adjacent wall composite panels, in such a way as to compress the wall composite panels along their length.

Said compression is useful to compress adjacent wall composite panels in order to provide good sealing and to facilitate the installation of cleats onto flanges that have been previously described.

Preferably, the wall composite panels are broken along their length as at 12a and 12b in order to fit onto air pallets.

Preferably, the wall panels are broken in the length of 12a and 12b and in a staggered or zigzag arrangement in order to strengthen the wall when assembled.

Preferably, window openings 1200 and door openings 1300 are fully contained within their respective wall composite panels and can be fully factory fitted as a result.

### Roof Finish and Securing Means

A roof finish 1400 covers from the apex of the roof down to the drip line on the perimeter of the building as shown in FIG. 11a which is a side view of the roof finish and securing means 1580 located along the wall of the building. FIG. 11b is a plan view of the securing means 1580 when installed along the vertical seams of the wall composite panels.

Preferably, the roof finish is weatherproof. Preferably, the roof finish is made of flexible material of any kind that is resistant to sun exposure, cold weather and fire.

Preferably, the weatherproof roof finish may be broken into smaller sections in order for it to be light enough to roll up and be carried up a ladder by one person in the field.

Preferably, the upper roof profile 1420 bears a slope greater than 1:24 but less than 1:12 by any means.

Preferably, the upper roof profile 1420 is made using one or more interlocking pieces of hard foam which can be packed efficiently for transport and fitted together creating a solid upper roof profile, by any means, including those that result in voids being carried underneath the solid upper roof profile.

Preferably a flexible and moisture permeable spacer layer 1430 is located between the weatherproof roof finish 1400 and the upper roof profile 1420 for the purpose of ventilating the underside of the weatherproof roof finish 1400. Spacer layer 1430 is similar to lining 220a and 220b as previously described, other than the fact that lining 220a and 220b is more rigid and needs to provide full coverage of the composite panels they are covering.

Preferably, the spacer layer 1430 is resistant to mold and/or rot, and compliant so as to protect the weatherproof finish 1400 when it is being walked upon.

Preferably, the spacer layer 1430 is ventilated with an edge 1440 located near the drip line of the roof finish 1400 around the building perimeter.

Preferably, roof finish 1400 stops on the other end at the apex of the roof with an edge equipped with Keder cord 1450 which fits into Keder extrusion 1500.

Preferably, the spacer layer 1430 is ventilated at the apex of the roof my any means.

Preferably, the ventilation means at the apex of the roof occurs through a Keder extrusion 1500 which bears apertures 1550. Said apertures allow spacer layer 1430 be exposed to exterior of the building.

Preferably, said apertures are made resistant to wind and/or water by such means including for example covering the apertures with semi permeable but water resistant membranes or covering the apertures with linear weather proof structures of any kind.

Preferably, the roof finish 1400 bears a Keder cord 1450 along the apex of the roof line in order to secure the roof finish 1400 to the Keder extrusion 1500 along the roof line.

Preferably, the roof finish 1400 is looped around a linear element 1560 (for example, a pole) and secured back to the roof finish by any means, as would be understood by a person skilled in the art.

Preferably, said linear means 1560 is pulled down by the fitment of securing means 1580 that is secured to the floor support by any means, which allows for tensioning of the linear element 1560 thus drawing the roof finish to the spacer layer 1430.

Preferably, said securing means is a strap 1580.

Preferably, strap 1580 is secured through holes 698 on plate 690 which is on top of 1-D pier (600) as described previously and shown in FIG. 5a.

Such a description of the roof finish includes any arrangement of the roof finish with Keder edges running along or across the building roof line.

Preferably, other than the Keder edge running along the length of the apex of the roof line, such Keder edges run vertically up the slope of the roof line in order to minimize opportunities for leakage during heavy rains.

Referring to FIG. 11b, preferably, securing means for roof finish is a strap 1580 (also acting as removable seal 270 as shown in FIG. 2i) which bears a double Keder cord with longitudinal edges 280a and 280b that are flexible and fit snugly into Keder type receiving channels 290a and 290b respectively located on either side of the vertical seams of wall composite panel on the exterior.

Preferably, said strap 1580 is made with plastic coated fibers for strength and durability when exposed to sun, cold and fire.

Preferably, said straps 1580 are located at the vertical seam of each composite wall panel on the exterior and serve to cover and protect the suspender straps 1000 (1000a and 1000b).

Preferably, Keder type receiving channels 290a and 290b are secured and to the exterior material 250, for example, cladding 80, which is located on the building exterior by fastening means for example, 300.

It can now be readily understood that there are suspender straps which retain the building to the floor support, and roof finish straps which retain the roof finish and underlying layers to the building with the following new and useful features.
1) the removable roof finish straps 1580 allow for replacement of the roof finish 1400 without having to undo the underlying suspender straps;
2) The removable roof finish straps 1580 provide a weatherproof covering for all vertical seams of wall composite panels, allowing easy inspection and maintenance of the underlying vertical seams and suspender straps while maintaining the contiguity of the ventilated aspect of the building façade;
3) The removable roof finish straps 1580 provide additional means for securing exterior materials 250, for example, cladding 80, across the vertical seams of the wall composite panel, thus strengthening the connection between adjacent wall composite panels because such cladding is rigidly connected to the underlying wall composite panel by fasteners 255 which have previously been described; and
4) The removable roof finish straps 1580 protect the underlying suspender straps, allowing the suspender straps to be specialized for economy as they do not require the same level of resistance to sun, cold and fire, allowing building structural straps to be similar to safe to handle, flexible and strong plastic materials such as TENAX commonly used in the shipping trade.

### Assembly Sequence

There is an advantage to assembling the floor support first, followed by placement of the floor composite panels, proceeding then to the assembly of the roof support using the convenience of the floor support platform and the 2-D rigid frame assemblies constructed.

Preferably, the roof support is assembled in “slices” using the 2-D rigid frame assembly, by first assembling the components of the 2-D rigid frame assembly horizontally on the floor platform, followed by tilting of the so-constructed 2-D rigid frame assembly up into position.

Construction of Building Unit for the Floor Support

2-D rectangular lattices may be constructed as previously described under the heading of “2-D Rectangular Lattice” (shown in FIGS. 3d-3h).

1-D piers may be constructed as previously described under the heading of “1-D Pier” (shown in FIGS. 5a-5g).

To connect a 1-D pier to its adjacent 2-D rectangular lattices, protrusions on the 1-D pier (at connecting points 610a, 610c as shown in FIG. 5a) are assembled onto the 1-D pier by connecting means, for example, at least one of bolted protrusions, eye-bolt, and forge welded protrusions as previously described. Preferably, said protrusions are assembled onto a 1-D pier in the factory and the 1-D piers arrive at the building site ready to be used.

Preferably, as previously described, a lower assembly at the bottom of 1-D pier comprises a steel insert 620 which carries a threaded void to receive a steel screw 630 is assembled onto the 1-D pier (shown in FIG. 5a).

Preferably, as previously described, an upper assembly at the top of 1-D pier bears a steel insert 670 at the top which carries a threaded void to receive a screw 680 in order to adjust the height of structural elements located above the 1-D pier (shown in FIG. 5a).

Preferably, when the 1-D piers are located at the perimeter of the building, screw 680 may further bear against a plate 690 that allow the plate 690 to rotate relative to screw 680 so that plate 690 can remain at a preferred orientation relative to the structural elements located above the 1-D pier. Preferably, the plate 690 bears at least one hole(s) 698 through which strap(s) may be looped to further secure 1-D piers (shown in FIG. 5a). Preferably, when the 1-D piers are located at the perimeter of the building (but excluding at the four corners of the building), a plate 690 may further bear a protrusion 695 (bulge stopper) on its top to restrain the movement of the structural elements (for example, 1-D column) located above the 1-D pier.

The 2-D rectangular lattices and the 1-D piers are connected by the tubular connecting assembly (340) as previously described with tubular element 350 and protrusions on the 1-D pier acting as object(s) 380 (shown in FIGS. 3a-3c).

Referring to FIG. 12a, each building unit 310 for the floor support (floor support unit) comprises four 2-D lattices 300 (300a, 300b, 300c and 300d) connected to four 1-D piers 600. Each 1-D pier 600 is equipped with protrusions, a lower assembly and an upper assembly drawn in simplified stick-figure format.

Diagonalizalion of Floor Support Unit 2-D triangular lattices may be constructed as previously described under the heading of “2-D Triangular Lattice” (shown in FIGS. 4a-4d).

Referring to FIG. 12b, one (shown) or two (not shown) 2-D triangular lattice 480 (480a) are connected to the floor support 310, as previously described (shown in FIG. 4a).

To connect a 1-D pier to its adjacent one or more 2-D triangular lattices, protrusions on the 1-D pier (at connecting points 610b shown in FIG. 5a) are assembled onto the 1-D pier by connecting means, for example, at least one of bolted protrusions, eye-bolt, and forge welded protrusions as previously described. Preferably, said protrusions are assembled onto a 1-D pier in the factory and the 1-D piers arrive at the building site ready to be used.

The one or more 2-D triangular lattices and the 1-D piers are connected by the tubular connecting assembly (340) as previously described with tubular element 350 and protrusions on the 1-D pier acting as object(s) 380 (shown in FIGS. 3a-3c).

Preferably, for economy, the 2-D triangular lattices are used singly per so called “bay” of the repeating building unit in which case their orientation will be reversed back and forth as one proceeds from bay to bay to maximize the diagonalization of the resulting structure.

Connecting Transoms Onto the Floor Support Unit

1-D transom may be constructed as previously described under the heading of “1-D Transom” (shown in FIGS. 6a-6h).

Referring to FIG. 12c, preferably, 2-D rectangular lattice with receiving means 345 assembled thereon in the factory arrive at the building site ready to be used.

Four 1-D transoms 800 are connected to the four 2-D rectangular lattices of floor support unit 310 through transom hub connectors (not shown) as previously described (shown in FIGS. 6c-6h).

The four 1-D transoms are laid onto the lower cupped washers of the transom hub connectors and into the vertical grooves of the fluted solid objects. Once all transoms are put into place, the upper cupped washers of the transom hub connectors may be tightened by a threaded fastener and/or a wedge pin against the fluted solid object to secure up to four 1-D transoms to the transom hub connector.

As previously described and shown in FIG. 6e, when transom hub connectors are located in the interior of the building structure, preferably, rod 895 bears a slot 896 at the top, said slot with a flat lower face and an angled upper face and is filled by a wedge pin 897.

As previously described and shown in FIG. 6f, when the transom hub connectors are located along the perimeter of the building structure, preferably, rod 895 with a slot 896 and wedge pin 897 therein bears a threaded end higher than slot 896. Preferably, plate 690 can be inserted over the threaded end of rod 895 secured by screwing on protrusion 695 of any kind (a bulge stopper), in order to restrain the movement of the structural elements (for example, 1-D column) located above the transom hub connector relative to the transom hub connector. Preferably, plate 690 may bear at least one hole(s) 698 through which strap(s) may be looped.

FIG. 12d is a lower perspective view of part of the floor support unit, shown are 2-D rectangular lattices 300a and 300b connected to 1-D piers 600. 1-D transoms 800 are connected to the 2-D rectangular lattices 300a and 300b through transom hub connectors 860. Transom hub connectors are each connected to the receiving means 345 located mid-point on the upper horizontal tube of each of 2-D rectangular lattices 300a and 300b, respectively. (The 2-D triangular members and connection points are left out in FIG. 12d for clarity.)

Repeating Until Floor Support is Built

Referring to FIGS. 12e and 12f, the above steps may be repeated one floor support unit 310 at a time, along the width A (short edge) and the principal direction B (long edge).

A person skilled in the part would understand that there is no particular preference of order of the repetition so long as the entire floor support as desired is built.

Laying Floor Composite Panels on the Floor Support

Floor composite panels are constructed as previously described under the heading of “Composite Panels” (as shown in FIGS. 1a-10.

Referring to FIG. 12f, a horizontal floor composite panel 10c is placed on the square of transoms such that the perimeter of the horizontal composite panel lies on the centerline of the four 1-D transoms 800.

Preferably, the inner layer (the layer located closest to the interior of the building structure) of a floor composite panel 10c is equipped with flanges along its edges as previously described (shown in FIGS. 2a to 20 so that adjacent composite panels can be bound together by a removable cleat inserted top side longitudinally along the outer edges of the flanges as previously described (shown in FIG. 2g).

The outer layer (the layer closest to the floor support and/or exterior of the building structure) of a floor composite panel is equipped with flanges along its edges as previously described (shown in FIGS. 2a to 2f) so that the flanges may be inserted into the upper pocket of the 1-D transoms as previously described (shown in FIGS. 6a and 6b).

Referring to FIG. 12g, a floor composite panel 10c so described may be securely laid over the square of four 1-D transoms which have been connected to the floor support unit 310. Said floor composite panel is then securely connected to its adjacent floor composite panel by the use of a removable cleat.

Preferably, for one or more of the floor composite panels, the apex of the 2-D triangular lattice within a floor support unit is coincident to the centroid of the outer layer of a floor composite panel located above. Preferably, the apex communicates with said centroid. Preferably, said means of communication is a field applied fastening means. Preferably, said fastening means is a loop (for example, loop 960 as previously described and shown in FIG. 8a).

As an illustrative example, shown in FIG. 12g, there are 3 (width)×2 (long) floor support units. There are 8 full square-shaped floor composite panels used.

Referring to FIG. 12h, triangular floor composite panels (10cc and10ccc) are required along the perimeter of the building to complete the floor. Composite panel 10cc is twice the size of composite panels 10ccc. Such triangular floor composite panels (one 10cc and two 10ccc) can be packed together in a square, the same size as a squared panel, facilitating transport by air using pallets. In the illustrative example as shown in FIG. 12g, the triangular floor composite panels can be packed as four full square panels for ease of transportation.

The triangular floor composite panels (10cc and 10ccc) are only equipped with flanges on the edges that are inboard of the triangle (i.e. the long edge of 1-ccc and the two short edges of 10cc), not along the edge(s) of the perimeter of the building (i.e. the two short edges of 10ccc and the long edge of 10cc). Where flanges are equipped, the inner layer (located closest to the interior of the building structure) is equipped with flanges so that adjacent composite panels are bound together by a removable cleat. The outer layer (closest to the floor support and/or exterior of the building structure) is equipped with flanges along its edges as previously described so that the flanges may be inserted into the upper pocket of the 1-D transoms as previously described.

This description does not preclude other panel dimensions and arrangements with appropriate flange locations, as would be understood by one practiced in the art, as long as the panels can be fitted to the building structure in the manner described.

As previously described, preferably, an upper assembly at the top of 1-D pier bears a steel insert at the top which carries a threaded void to receive a screw in order to adjust the height of structural elements located above the 1-D pier. Preferably, when the 1-D piers are located at the perimeter of the building, the screw may further bear against a plate that allows the plate to rotate relative to screw in order that plate can remain at a preferred orientation relative to the structural elements located above the 1-D pier, and the plate bears at least one hole(s) through which strap(s) may be looped to further secure 1-D piers, this upper structure is noted in FIG. 12h as 1610. This feature is useful later on to retain the corner wall composite panels. Preferably, when the 1-D piers are located at the perimeter of the building (but excluding at the four corners of the building), a plate may further bear a protrusion (a bulge stopper) on its top, in order to restrain the movement of the structural elements located above the 1-D pier (for example, 1-D column), this upper structure is noted in FIG. 12h as 1620. This feature is useful later on to retain the 1-D columns to be inserted over the bulge stoppers.

As previously described and shown in FIG. 6f, when a transom hub connector is connected to a 2-D rectangular lattice where the 2-D rectangular lattice in located at the perimeter of the building structure, preferably, the rod 895 with slot 896 and wedge pin 897 therein bears a threaded end higher than slot 896. Preferably, plate 690 can be inserted over the threaded end of rod 895 secured by screwing on protrusion 695 of any kind (a bulge stopper), in order to restrain the movement of the structural elements (for example, 1-D column) located above the transom hub connector relative to the transom hub connector, thus securing the structural elements to the transom hub connector, this upper structure is noted in FIG. 12h as 1630. This feature is useful later on to retain the 1-D columns to be inserted over the bulge stoppers.

Referring to FIGS. 12i, when floor composite panels 10c, 10cc, or 10ccc interfere with 1-D columns (at 1620 and 1630 shown in FIG. 12h), notches (11c, 11cc and 11ccc) are made within said floor composite panels 10c, 10cc, or 10ccc respectively so to allow 1-D columns to go through said floor composite panels and bear upon the 1-D pier and transom hub connectors located there under.

Referring to FIG. 12j, floor composite panels 10c, 10cc, or 10ccc with notches (not shown) allow 1-D columns 900 to go through said floor composite panels and inserted over the bulge stoppers 695 which are located on plates 690 (plates 690 with hole 698 are located at 1620 and 1630 shown in FIG. 12h).

Again referring to FIG. 12j, where floor composite panels 10c, 10cc, or 10ccc are in contact with wall composite panels 10a/10b at the bottom perimeter of the building, each of wall composite panels 10a/10b has a cutout portion so that the floor composite panels 10c, 10cc, or 10ccc are in set to each of the wall composite panel 10a/10b such that the inner portion 11b of each of the wall composite panel 10a/10b terminates and rests on the upper surface of the adjacent floor composite panel 10c, 10cc, or 10ccc. This was also previously described in FIG. 10b.

Once the floor composite panels are secured over the floor support, the floor becomes a working surface for the next step.

Adding Corner Wall Composite Panels

Referring to FIG. 13a, preferably, the corner wall composite panels 10bb located at the corners of the building are pre-factory made. Preferably, each said corner wall composite panel is made as one piece, i.e. monolithic. This one-piece feature of the corner wall composite panels replaces the need to have 1-D columns at the corners of the building. It also assists the horizontal banding applied to the perimeter building to drive the corners into the adjacent wall composite panels to compress the wall composite panels.

This does not preclude the division of the “L” shaped monolithic corner pieces into smaller pieces that are lighter and therefore easier to handle, where the “L” shape is retained and parting lines are introduced horizontally, such that monolithic “L” shaped corners pieces can be easily stacked on top of each other in the field in their final resting place on the building.

The corner wall composite panel 10bb has two edges along its lower extremity when said panel is placed on the floor at the corner of the building, wherein the two edges of said corner wall composite panel are vertical to each other. Each said edge is about the same length of each of the shorter edges of triangular floor composite panel 10ccc, pre-notches and/or pre-cutouts as previously described.

As previously described, where floor composite panels 10ccc is in contact with corner wall composite panels 10bb at the bottom corners of the building, each of wall composite panels 10bb has a cutout portion so that its adjacent floor composite panel 10ccc is in set to the wall composite panel 1-bb such that the inner portion of the wall composite panel 10bb terminates and rests on the upper surface of the adjacent floor composite panel 10ccc.

Each of two corner wall composite panels 10bb is set at the bottom corners of width A (short edge) of the building. The two said corner wall composite panels 10bb so constructed now define the perimeter of the “end wall” of the building.

A person skilled in the art would understand that corner wall composite panels 10bb do not have to be added to the floor support only after the entire floor is built. Rather, they can be added to the floor support whenever convenient.

For a corner wall composite panel 10bb, flanges are added along its vertical long edges at the two outer extremities of said panel, and not along the vertical edge at the corner of the building. Where flanges are added, both the inner layer and the outer layer of corner wall composite panel are equipped with flanges as previously described (shown in FIGS. 2a to 2f) so that adjacent composite panels can be bound together by a removable cleat inserted longitudinally along the outer edges of the flanges as previously described (shown in FIG. 2g).

Preferably, each of the abutting vertical faces of corner wall composite panel 10bb bears an edge profile 85 as previously described (shown in FIGS. 1k, 7b).

Building 1-D Column Next to Corner Wall Composite Panel

1-D columns may be constructed as previously described under the heading of “1-D Column” (shown in FIGS. 7a-7c).

Referring to FIG. 13b, preferably, the 1-D column 900 is fit snugly into the edge profile 85 of the corner wall composite panel 10bb.

Preferably, the bottom of 1-D column 900 (900BB) is tilted and inserted over bulge stopper (695, not shown) located on 1630 (upper assembly over transom hub connector located on the perimeter) as previously described.

Adding Wall Composite Panel Next to 1-D Column

Wall composite panels are constructed as previously described under the heading of “Composite Panels” (as shown in FIGS. 1a-1i).

Referring to FIG. 13b, a wall composite panel 10a/10b has a width that is about the same length of each of the shorter edges of triangular floor composite panel 10ccc, pre-notches and/or pre-cutouts as previously described, or about the distance from adjacent 1620 to 1630 (not shown in FIG. 13b, shown in FIG. 12h).

As previously described where floor composite panels are in contact with wall composite panels 10a/10b at the bottom perimeter of the building, each of wall composite panels 10a/10b has a cutout portion so that the floor composite panels are in set to each of the wall composite panel 10a/10b such that the inner portion of each of the wall composite panel 10a/10b terminates and rests on the upper surface of the adjacent floor composite panel.

For a wall composite panel 10a/10b, flanges are added along its vertical long edges at the two outer extremities of said panel. Where flanges are added, both the inner layer and the outer layer of corner wall composite panel are equipped with flanges as previously described (shown in FIGS. 2a to 2f) so that adjacent composite panels can be bound together by a removable cleat inserted longitudinally along the outer edges of the flanges as previously described (shown in FIG. 2g).

Preferably, each of the abutting vertical faces of wall composite panel 10a/10b bears an edge profile 85 as previously described (shown in FIGS. 1k, 7b).

Referring to FIG. 13b again, along the width A (short edge) of the building, wall composite panel 10a/10b so constructed is placed next to the 1-D column 900, where the edge profile 85 on the wall composite panel 10a/10b fits snugly against 1-D column 900.

Corner wall composite panel 10bb and wall composite panel 10a/10b are bound together by a removable cleat inserted longitudinally along the outer edges of the flanges as previously described (shown in FIG. 2g). The cleat binding action on both the inner and outer layers of corner wall composite panel 10bb and wall composite panel 10a/10b further tightens the 1-D column 900 inserted between these panels.

Similarly, 1-D column 900 and one more wall composite panel 10a/10b may be added along principal direction B (long edge) of the building.

There is no preference of order when adding the wall composite panel 10a/10b along the short edge A or long edge B so long that only one wall composite panel 10a/10b is added along long edge B next to corner wall composite panel 10bb.

Furthermore, cleated panel edges may exist vertically or horizontally as needed to join wall pieces across their seams.

Preferably any such horizontal cleats are added before the wall panel is lifted into place on the structure and conversely vertical cleats are added after the wall panel is lifted into place on the structure.

Referring to FIG. 13c, steps are repeated until additional wall composite panels 10a/10b and 1-D columns are built along the entire length of short edge A.

Building of 2-D Rigid Frame Assembly

A 2-D rigid frame assembly was previously described under the heading of “2-D Rigid Frame Assembly” (as shown in FIG. 7c).

Referring to FIG. 7c, a 2-D rigid frame assembly 950 can be constructed using the parts previously described.

The height of the 2-D rigid frame assembly 950 (shown in FIG. 7c as height of 600a/600c +900a+900b) is the same as the vertical height of the corner wall composite panel.

Building Roof Support

Referring to FIG. 13c, as described previously, once assembled, the top of said 2-D rigid frame assembly may be tilted or rotated upwards such that the bottom of each of the 1-D column 900 (within the assembly 950) is inserted over bulge stopper (695, not shown) located on 1620 (upper assembly over 1-D pier located on the perimeter except the four corners) as previously described.

Preferably, the 2-D rigid frame assembly is sufficiently light that it can be tilted into place by hand using ropes for tugging and stabilization.

As previously described, there are two types of columns, the longer columns 900BB (with transom hub connectors on top) that transect the middle of the repeating cell structure along the perimeter of the building; and the shorter 1-D columns 900AA (with a 1-D pier on top) where the column to pier connection is by means of a moment resisting spigot 595 that is pinned at both ends by pins 370 (shown in FIG. 7a). Therefore, the long columns and short columns alternate along the perimeter of the building except at the four corners where there is no column but rather 1-piece corner wall composite panels 10bb.

Furthermore, the inside cleats that joined panel edges may exist vertically or as needed to join wall pieces across their seams.

Referring to FIG. 13d, additional 2-D rectangular lattices 300BB are used to connect or bridge the 2-D rigid frame assembly 950 already put vertically in place and the short end wall of the building, using tubular connecting assemblies (between 2-D rectangular lattice and 1-D pier) as previously described. As an illustrative example, there are two additional said 2-D rectangular lattices 300BB used to build the roof support which will support the roof composite panels.

Diagonalization of Roof Support Unit

Similar to the diagonalization of the floor support unit, preferably, roof support is also diagonalized.

Referring to FIG. 13e, 2-D triangular lattice 480 (480a) are connected to the roof support unit 320, as previously described (shown in FIG. 4a).

Because the corners of the building in the roof support do not contain 1-D column, nor 1-D piers, only one lattice 480a (shown in the left end) or 480b (shown in the right end) may be added, utilizing the protrusion at position 610b located on the 1-D piers in the roof support. For interior roof support unit, one or both triangular lattice 480a and/or 480b may be used.

Connecting Transoms Onto the Roof Support Unit

As previously described, the longer columns 900BB bear a treaded void to receive a transom hub connector (860). The diameter of the columns is commensurate to the diameter of receiving means 345. A transom hub connector is connected to the top of longer column 900BB to connect a 1-D transom to said longer column similarly to the way a transom hub connector is connected to a 2-D rectangular lattice to connect a 1-D transom to said rectangular lattice as previously described.

Referring to FIG. 13f, preferably, similar to connecting 1-D transoms onto the floor support unit, preferably, 1-D transoms 800 are also added onto the roof support unit 320.

Repeating Mill Roof Support is Built

The above steps may be repeated one floor support unit 320 at a time, along the width A (short edge) and the principal direction B (long edge).

A person skilled in the part would understand that there is no particular preference of order of the repetition so long as the entire floor support as desired is built.

Laying Roof Composite Panels on the Roof Support

Roof composite panels are constructed as previously described under the heading of “Composite Panels” (as shown in FIGS. 1a-1i).

Referring to FIG. 13g, preferably, similar to laying the floor composite panels on the floor support, floor composite panels are laid the roof support.

A horizontal roof composite panel 10d is placed on the square of transoms such that the perimeter of the horizontal composite panel lies on the centerline of the four 1-D transoms 800.

Preferably, the outer layer (located closest to the exterior of the building structure) of a roof composite panel 10d is equipped with flanges along its edges as previously described (shown in FIGS. 2a to 2f) so that adjacent composite panels can be bound together by a removable cleat inserted top side longitudinally along the outer edges of the flanges as previously described (shown in FIG. 2g).

The inner layer (closest to the roof support and/or interior of the building structure) of a roof composite panel is equipped with flanges along its edges as previously described (shown in FIGS. 2a to 2f) so that the flanges may be inserted into the upper pocket of the 1-D transoms as previously described (shown in FIGS. 6a and 6b).

A floor composite panel 10d so described may be securely laid over the square of four 1-D transoms which have been connected to the roof support unit. Said roof composite panel is then securely connected to its adjacent roof composite panel by the use of a removable cleat.

Preferably, for one or more of the roof composite panels, the apex of the 2-D triangular lattice within a roof support unit is coincident to the centroid of the inner layer of a roof composite panel located above. Preferably, the apex communicates with said centroid. Preferably, said means of communication is a field applied fastening means. Preferably, said fastening means is a loop (for example, loop 960 as previously described and shown in FIG. 8a).

Referring to FIG. 13g, triangular roof composite panels (10dd and 10ddd) are required along the perimeter of the building to complete the floor. Composite panel 10dd is twice the size of composite panels 10ddd. Such triangular floor composite panels (one 10dd and two 10ddd) can be packed together in a square, the same size as a squared panel, facilitating transport by air using pallets.

The triangular roof composite panels (10dd and 10ddd) are only equipped with flanges on the edges that are inboard of the triangle (i.e. the long edge of 10ddd and the two short edges of 10dd), not along the edge(s) of the perimeter of the building (i.e. the two short edges of 10ccc and the long edge of 10cc). Where flanges are equipped, the outer layer (closest to the exterior of the building structure) is equipped with flanges so that adjacent composite panels are bound together by a removable cleat. The inner layer (located closest to the roof support and/or interior of the building structure) is equipped with flanges along its edges as previously described so that the flanges may be inserted into the upper pocket of the 1-D transoms as previously described.

There are no columns to be inserted onto the transom hub connectors and 1-D piers located in the roof support, therefore, there is no need to specialize the top of the transom hub connectors and 1-D piers located in the roof support as in the floor support. A person skilled in the art would understand however that if a second story is to be built, the transom hub connectors, 1-D piers will to be specialized as disclosed herein to receive a 1-D column, such is also the case if 1-D column is to be built in the interior of the building.

Roof composite panels 10d, 10dd, or 10dd do not have notches as for the floor composite panels, however, if a second story is to be built, they may require notches. Notches can be used so economize on the number of parts, which means that all floor and roof composite panels would be interchangeable which is highly desirable.

When roof composite panels 10d, 10dd, or 10ddd are in contact with wall composite panels 10a/10b at the top perimeter of the building, each of wall composite panel 10a/10b has a cutout portion so that the roof composite panel 10d, 10dd, or 10ddd are in set to the wall composite panel 10a/10b such that lower surface of the adjacent roof composite panel 10d, 10dd, or 10ddd terminates and rests on the inner portion 11a of the wall composite panel 10a/10b. This was also previously described in FIG. 10b.

Adding Wall Composite Panels, 1-D Columns and Corner Wall Composite Panels

As previously described, the steps of adding wall composite panels, 1-D columns and corner wall composite panels may be repeated until the entire 3-D building structure is built and covered with roof, wall and floor composite panels.

The length of the vertical cleats on the inner layer of the wall composite panels may need to be adjusted so not to interfere with the 1-D piers that is on top of the short columns on the perimeter of the building, said 1-D piers are connected to the bridging 2-D rectangular lattices (for example, 300BB as shown in FIG. 13d).

Strapping the Building Structure

Suspender straps and belts straps may be strapped around the building structure as previously described under the heading of “Straps” (shown in FIGS. 10a-10c).

Referring to FIG. 14a, one or more belt straps 1100 are strapped horizontally around the perimeter of the building as previously described. One or more suspender straps 1000 are strapped vertically around the building structure as previously described. There is no preference of order of how the straps are to be applied except that they should be applied in an economical and convenient manner. Tightening means such as a rotary ratchet may be used.

Suspender straps may be replaced with shorter straps binding lower wall panels to the adjacent plates located on the 1-D piers by any means, as has been previously mentioned.

Roof Finishing

Roof finish, upper roof profile, spacer layer, securing means may be applied to the building structure as previously described under the heading of “Roof Finish and Securing Means” (shown in FIGS. 11a-11b).

Referring to FIG. 14b, each piece of roof finish 1400 bears a Keder cord 1450 along the apex of the roof line in order to secure said roof finish 1400 to the Keder extrusion 1500 along the roof line.

As previously described, each roof finish is looped around a linear element (for example, a pole) and secured back to the roof finish by any means, wherein the linear means is pulled down by the fitment of securing means that is secured to the floor support, which allows for tensioning of the linear element thus drawing the roof finish to the spacer layer.

Preferably, securing means for roof finish is as previously described and shown in FIGS. 11a and 11b is a strap 1580 (also acting as removable seal 270 as shown in FIG. 2i) which bears a double Keder cord with longitudinal edges 280a and 280b that are flexible and fit snugly into Keder type receiving channels 290a and 290b respectively located on either side of the vertical seams of wall composite panel on the exterior.

Therefore, the removable seal 270 protecting wall panel vertical seams can also serve as a strap 1580 to attach the roof fabric 1400 to the plates (for example, plate 690 not shown) located on the 1-D piers thus securing the roof fabric to the building by removable means that does not interfere with the securing of the building envelope using suspender straps and/or belt straps as previously described.

Preferably, the top of strap 1580 is attached to the roof fabric 1400 by looping around a pole or linear element (for example, 1560 as shown in FIG. 11a) rolled into the roof fabric 1400 horizontally at the drip line of the building.

Preferably, the bottom of strap 1580 is attached to a plate (for example, plate 690 not shown) located on the 1-D piers by ratchet tightening means.

The removable seal 270 protecting the vertical seams between the wall composite panels can also serve to conceal and therefore protect the suspender straps over the wall composite panels and connected to a plate (for example, plate 690 not shown) located on the 1-D piers.

While this invention has been described as having an exemplary design, the present invention may be further modified within the scope of this disclosure. This application is therefore intended to cover any variations, uses, or adaptations of the invention using its general principles. Further, this application is intended to cover such departures from the present disclosure as come within known or customary practice in the art to which this invention pertains.

1-9. (canceled)

10. A panel assembly comprising:
two adjacent panels,
two L-shaped flanges, each formed from a flat sheet bent along a bend line,
each of said L-shaped flanges has a horizontal face and a vertical face,
each of said panels is attached from the bottom to the horizontal face of each of the flanges in a direction away from the vertical face,
the vertical face of each the flanges are placed parallel and abut with each other when the flanges are brought together,
wherein each of the vertical face comprises apertures, protrusions, or both,
wherein the apertures and/or protrusions located in the first vertical face are reciprocal with the protrusions and/or apertures located in the second vertical face as opposite pairs,
wherein said apertures and/or protrusions located in the first vertical face mate with the protrusions and/or apertures located in the second vertical face when the first and second vertical faces are brought together across an abutting face that exists between the abutting flanges, and
wherein said abutting face comprises flat area to provide a positive stop for the engagement of the protrusions and the apertures.

11. The panel assembly according to claim 10, wherein the flat area further comprises an upper closure strip comprising a flat area on the vertical face above the apertures and/or protrusions; a lower closure strip comprising a flat area on the vertical face below the apertures and/or protrusions, or both.

12. The panel assembly according to claim 11, where a sealant is added along the lower closure strip.

13. The panel assembly according to claim 10, wherein the flanges are brought together by binding means.

14. The panel assembly according to claim 13, wherein the binding means is a removable cleat inserted top side longitudinally along the outer edges of vertical faces of the flanges.

15. A panel assembly comprising:
two adjacent panels,
two L-shaped flanges, each formed from a flat sheet bent along a bend line,
each of said L-shaped flanges has a horizontal face and a vertical face,
each of said panels is attached from the bottom to the horizontal face of each of the flanges in a direction away from the vertical face,
the vertical face of each of the flanges are placed parallel and abut with each other when the flanges are brought together by binding means,
wherein the binding means is a removable cleat.

16. The panel assembly according to claim 15, wherein the removable cleat is inserted top side longitudinally along the outer edges of vertical faces of the flanges.

17. The panel assembly according to claim 15,
wherein each of the vertical face comprises apertures, protrusions, or both,
wherein the apertures and/or protrusions located in the first vertical face are reciprocal with the protrusions and/or apertures located in the second vertical face as opposite pairs,
wherein said apertures and/or protrusions located in the first vertical face mate with the protrusions and/or apertures located in the second vertical face when the first and second vertical faces are brought together across an abutting face that exists between the abutting flanges, and
wherein said abutting face comprises a flat area to provide a positive stop for the engagement of the protrusions and the apertures.

18. The panel assembly according to claim 15, wherein each of the flanges bears an additional bend line, said bend line is substantially perpendicular to the abutting face to create a flat portion at the outer extremity of the flanges.

19. The panel assembly according to claim 18, wherein the removable cleat is inserted top side longitudinally along the outer edges of vertical faces of the flanges and over the flat portion at the outer extremity of the flanges.

20-44. (canceled)

45. A method for building a rapidly deployable building structure, comprising the steps of:
(a) constructing a floor support unit by connecting four rectangular lattices to four piers by tubular connecting assemblies,
(b) optionally diagonalizing the floor support unit by constructing one or more triangular lattices within said unit,
(c) connecting four structural beams or transoms onto the floor support unit by using structural beam hub connecting assembly,
(d) repeating steps (a) to (c) until floor support is built,
(e) laying floor composite panels on squares of four structural beams or transoms connected on top of the floor support,
(f) adding corner wall composite panels,
(g) building one column next to in each of the corner wall composite panels wherein the column fits snuggly into a profile edge created in the corner wall composite panels,
(h) adding wall composite panel next to the columns,
(i) forming a roof support of a building structure, comprising the steps of:
1) assembling horizontally a rigid frame assembly comprising two columns, piers and one or more rectangular lattices,
2) tilting the rigid frame assembly upwards wherein the bottom of the columns are placed onto a movement restraining structure comprising a protrusion on top of a plate wherein said movement restraining structure is located on a pier or a structural beam hub connector assembly,
3) restraining movement of the rigid frame assembly by the close fit up of wall panels adjacent to the columns, wherein the wall panels are fastened around the columns by a cleat inserted top end longitudinally along the outer edges of vertical faces of flanges attached to the wall panels,
4) adding sequential placement overhead of piers and rectangular lattice to form a roof support unit,
5) diagonalizing the roof support unit by constructing one or more triangular lattices within said unit,
6) repeating steps 1) to 5) along the direction of the building length,
7) forming the roof support of a building structure,
(k) connecting four structural beams or transoms onto the roof support unit by using structural beam hub connecting assembly,
(l) laying roof composite panels on squares of four structural beams or transoms connected on top of the roof support,
(m) adding wall composite panels, columns and corner wall composite panels to finish the building structure,
(n) optionally strapping the building structure, and
(o) optionally adding a roof finish to the building structure.
